(19) United States
(12) Patent Application Publication
(10) Pub. No.: US 2014/0089579 A1
(43) Pub. Date: Mar. 27, 2014

(54) INFORMATION PROCESSING SYSTEM, RECORDING MEDIUM, AND INFORMATION PROCESSING METHOD

(71) Applicant: FUJITSU LIMITED, Kawasaki-shi (JP)

(72) Inventors: Noriaki KUROKAWA, Yokohama (JP); Kenichirou Shimogawa, Numazu (JP); Soichi Shigeta, Yokohama (JP)

(73) Assignee: FUJITSU LIMITED, Kawasaki-shi (JP)

(21) Appl. No.: 13/962,504

(22) Filed: Aug. 8, 2013

(30) Foreign Application Priority Data
Sep. 21, 2012 (JP) 2012-208133

(51) Int. Cl. G06F 3/06

(52) U.S. Cl. CPC G06F 3/0674; G06F 3/0634; G06F 3/0604
USPC 711/112

(57) ABSTRACT

An information processing system that sets, coupling information defining a logically coupling corresponding to a first disk, to an uncoupled state indicating that a first logical machine associated with the first disk and the first disk are not coupled, in response to a request to stop the first logical machine, and releases a coupling between the first logical machine and the first disk based on the uncoupled state set in the coupling information.

### CROSS-REFERENCE TO RELATED APPLICATION

This application is based upon and claims the benefit of priority of the prior Japanese Patent Application No. 2012-208133, filed on Sep. 21, 2012, the entire contents of which are incorporated herein by reference.

### FIELD

The embodiment discussed herein is related to an information processing system, a recording medium, and an information processing method.

### BACKGROUND

As the use of cloud computing, a service is provided by defining specifications of a logical machine by a service administrator who manages the service, requesting an infrastructure administrator who manages a cloud platform to assign physical resources for the specifications, and executing the logical machine to which the physical resources have been assigned.

FIG. 1 illustrates an example of the use of the cloud computing. A service administrator of a business owner who provides a service using a cloud platform 10 specifies virtual machine's specifications 20 such as a processing speed of a central processing unit (CPU), a capacity of a memory, a band of a network interface card (NIC), and a capacity of a disk, and thereby defines, as a logical machine, a virtual machine 30 to be executed on the cloud platform 10. In addition, the service administrator specifies physical machine's specifications 40 such as the type of a rack server or blade server and a capacity of a disk and thereby defines, as a logical machine, a physical machine 50 to be executed on the cloud platform 10. The service administrator defines configurations and specifications of the logical machines based on the contents of the service and the state of the service provided or to be provided and manages the logical machines so that the service is provided in a desired manner.

When an infrastructure administrator who manages the cloud platform 10 receives information of a specification of a logical machine and a request to assign a physical resource from the service administrator, the infrastructure administrator confirms a usage status of a resource pool 60 managed by the infrastructure administrator. If the physical resource is enabled to be assigned for the requested specification, the physical resource is assigned to the logical machine, and the logical machine is executed on the cloud platform 10. Since a plurality of logical machines are executed on the cloud platform 10, the infrastructure administrator adjusts assignments of physical resources based on execution states of logical machines in order to ensure the requested specification. In addition, the infrastructure administrator causes mirroring of a disk to be executed in order to have redundancy of data to be managed, switches disks, couples a disk, and the like. The resource pool 60 managed by the infrastructure administrator includes a CPU resource pool 61 including CPU resources, a memory resource pool 62 including memory resources, a disk resource pool 63 including disk resources, and a physical server 64 such as a rack server or a blade server. An assignment and adjustment of a physical resource included in the resource pool 60, a coupling and switching of a disk, and the like are executed under the authority of an infrastructure supervisor.

Assignments of disks to logical machines on the cloud platform 10 includes a shared assignment that causes a disk to be shared by multiple logical machines, and a dedicated assignment that causes a specific disk to be assigned to a specific logical machine. For example, in order to couple a logical machine to a disk storing information to be disclosed to multiple logical machines or a disk storing information to be shared and used, the service administrator defines a specification of a disk resource and defines that an assignment of the disk is the shared assignment. If the shared assignment is defined for logical machines, the infrastructure administrator permits a disk to be shared by the logical machines.

In order to couple a logical machine to a disk storing information specific to an operating system (OS) of the logical machine or a disk storing information that is not to be disclosed to another logical machine, the service administrator defines a specification of a disk resource and defines that an assignment of the disk is the dedicated assignment. The infrastructure administrator assigns, in a dedicated manner, the disk to the logical machine for which the dedicated assignment is defined. In this case, even if the logical machine does not access the disk, another logical machine is not coupled to the disk. For example, when the logical machine is stopped by the service administrator, assignments of a CPU resource and a memory resource to the stopped logical machine are released, and the resources become physical resources that are enabled to be assigned to another logical machine. The dedicated assignment of a disk to the stopped logical machine is not released in order to inhibit information specific to the logical machine from being overwritten by accessing the interested disk by another logical machine.

When the service administrator requests the infrastructure administrator to assign a physical resource, a requested specification is only registered on the side of the infrastructure administrator, and the physical resource is not assigned. When the service administrator requests the infrastructure administrator to activate a logical machine, a CPU resource, a memory resource, and the like are assigned. This is due to the fact that finite physical resources are released in a time period in which the logical machine is not executed in order to effectively use the physical resources.

As described above, in order to ensure consistency of data based on an usage status of a disk, a logical machine and the disk are associated with each other so as to ensure a coupling of the logical machine to the disk in an assignment mode and are registered when specifications of the logical machine are registered by the infrastructure administrator. When activation of the logical machine is requested by the service administrator, the logical machine is coupled to the associated disk and the disk becomes accessible in the mode associated to the disk.

As a technique for executing exclusive control so as to cause a resource to be excessively shared by multiple physical servers, the following technique is known. When a bit that corresponds to a resource to be accessed and is stored in a management region corresponding to a certain server executed on a common device is on, and a bit that corresponds to the interested resource and is stored in a management region corresponding to another server is off, the technique causes the access to be executed as success of the exclusive control.

Japanese Laid-open Patent Publication No. 2003-85026 is an example of related art.

### SUMMARY

According to one exemplary embodiment, the disclosure is directed to an information processing system that sets, coupling information defining a logically coupling corresponding to a first disk, to an uncoupled state indicating that a first logical machine associated with the first disk and the first disk are not coupled, in response to a request to stop the first logical machine, and releases a coupling between the first logical machine and the first disk based on the uncoupled state set in the coupling information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of the use of cloud computing;

FIG. 2 illustrates an information processing system to which the embodiment is applicable, and a hardware configuration of the information processing system;

FIG. 3 illustrates logical machine management information to be used by the information processing system to which the embodiment is applicable;

FIG. 4 illustrates disk resource management information to be used by the information processing system to which the embodiment is applicable;

FIG. 5 illustrates functional blocks to be executed by a management server to which the embodiment is applicable;

FIGS. 6A and 6B illustrate an example of a process of registering an assignment of a disk to a logical machine by the information processing system to which the embodiment is applicable;

FIG. 7 illustrates an example of a process of releasing an assignment of a disk to a logical machine by the information processing system to which the embodiment is applicable;

FIG. 8 illustrates an example of a process of setting coupling information of a disk to an uncoupled state by the information processing system to which the embodiment is applicable;

FIGS. 9A and 9B illustrate an example of a process of coupling a logical machine to a disk by the information processing system to which the embodiment is applicable;

FIGS. 10A to 10C illustrate an application example of the information processing system to which the embodiment is applicable;

FIGS. 11A to 11C illustrate execution states of the application example of the information processing system to which the embodiment is applicable;

FIGS. 12A to 12C illustrate other execution states of the application example of the information processing system to which the embodiment is applicable;

FIGS. 13A to 13C illustrate other execution states of the application example of the information processing system to which the embodiment is applicable;

FIGS. 14A to 14C illustrate other execution states of the application example of the information processing system to which the embodiment is applicable;

FIGS. 15A to 15C illustrate another application example of the information processing system to which the embodiment is applicable;

FIGS. 16A to 16C illustrate execution states of the other application example of the information processing system to which the embodiment is applicable;

FIGS. 17A to 17C illustrate other execution states of the other application example of the information processing system to which the embodiment is applicable;

FIGS. 18A to 18C illustrate other execution states of the other application example of the information processing system to which the embodiment is applicable; and

FIG. 19 illustrates an example in which a logical machine coupled to a disk in a dedicated mode is switched.

### DESCRIPTION OF EMBODIMENT

First, inventors' ideas regarding cloud computing are described. For cloud computing, an infrastructure administrator who manages a cloud platform has an authority to switch and couple disks. Thus, a service administrator does not change a disk assigned to a logical machine to another disk without approval of the infrastructure administrator.

For example, when a logical machine that is coupled to a disk is stopped due to an error of the disk or the like, the coupling of the disk to the logical machine is not released without the authority of the infrastructure administrator. Thus, even if an assignment of the logical machine to another disk is registered, the service administrator waits for the infrastructure administrator to release the disk in order to restart a service. In this case, if support for the infrastructure administrator is not sufficient, the service may be stopped during the time when the disk is not completely released.

According to the embodiment described later, a coupling of a logical machine to a disk may be released by a computer that provides a request to stop the logical machine via a coupling information defining a logically coupling between a logical machine and a disk associated with the logical machine and referred when a physically coupling between the logical machine and a disk is controlled.

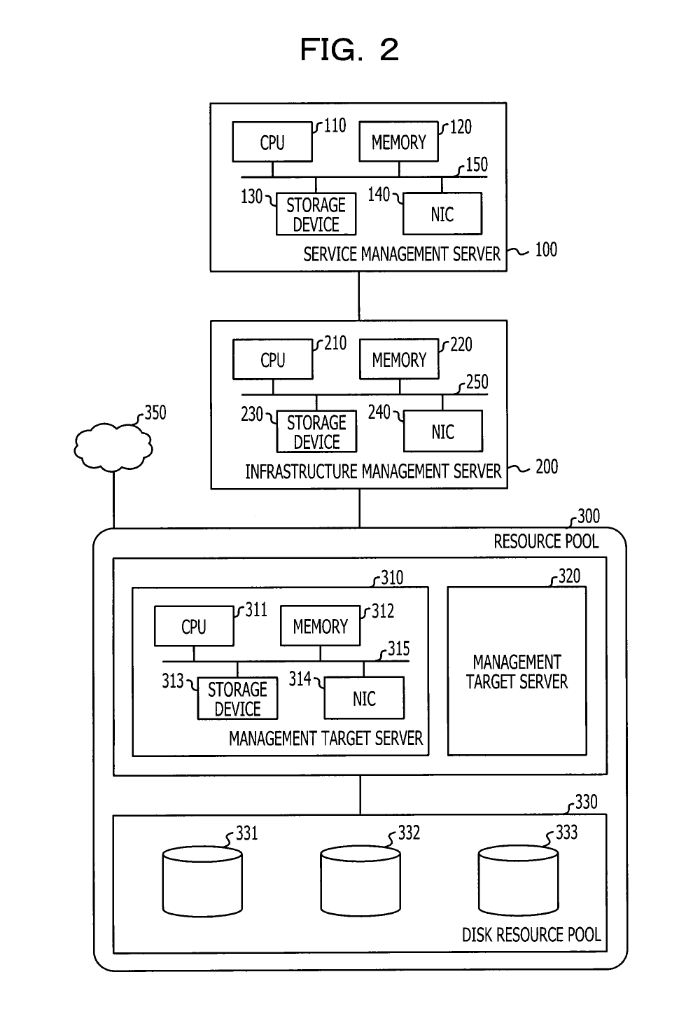

FIG. 2 illustrates an information processing system to which the embodiment is applicable, and a hardware configuration of the information processing system. The information processing system includes a service management server 100, an infrastructure management server 200, and a resource pool 300. The resource pool 300 includes a server 310 to be managed, a server 320 to be managed, and a disk resource 330.

The service management server 100 is a computer that includes a CPU 110, a memory 120, a storage device 130, an NIC 140, and a bus 150. The bus 150 couples the CPU 110, the memory 120, the storage device 130, and the NIC 140 to each other. The CPU 110 includes at least one processor that executes a process. The memory 120 is, for example, a random access memory (RAM). The storage device 130 is a nonvolatile memory such as a read only memory (ROM) or a flash memory or a magnetic disk device such as a hard disk drive (HDD). The NIC 140 is an interface circuit that transmits and receives data to and from an external device. The service management server 100 communicates with the infrastructure management server 200 through the NIC 140.

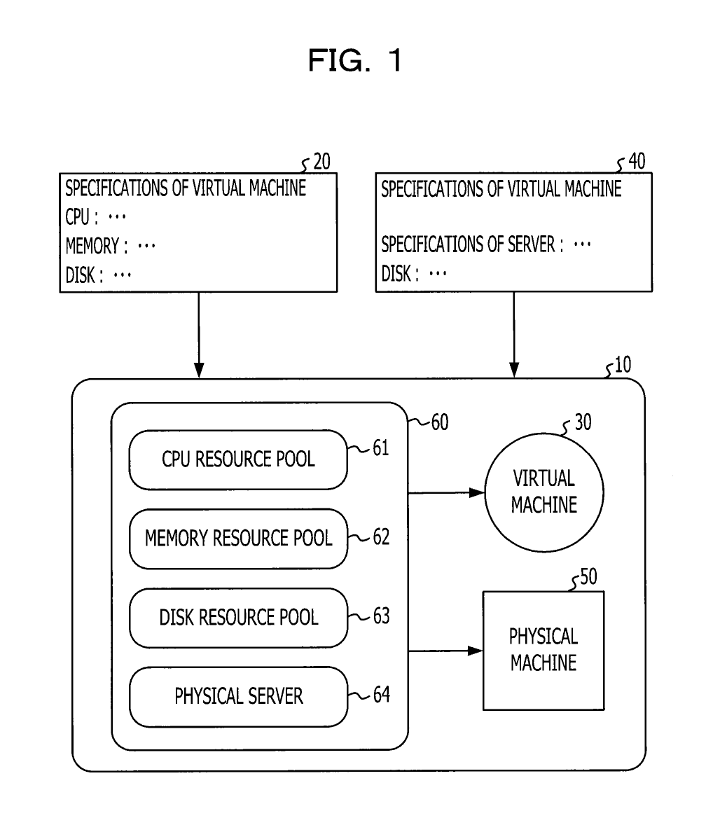

A program in which a process of controlling the service management server 100 is described is stored in the memory 120. An operation of the service management server 100 is controlled by causing the CPU 110 to execute the program stored in the memory 120. The service management server 100 defines specifications of a logical machine as illustrated in FIG. 1 and requests the infrastructure management server 200 to cause the logical machine to be executed with the defined specifications.

The infrastructure management server 200 is a computer that includes a CPU 210, a memory 220, a storage device 230, an NIC 240, and a bus 250. The bus 250 couples the CPU 210, the memory 220, the storage device 230, and the NIC 240 to each other. The CPU 210 includes at least one processor that executes a process. The memory 220 is, for example, a RAM. The storage device 230 is a nonvolatile memory such as a ROM or a flash memory or a magnetic disk device such as an HDD. The NIC 240 is an interface circuit that transmits and receives data to and from an external device. The infrastructure management server 200 communicates with the service management server 100 and the resource pool 300 through the NIC 240.

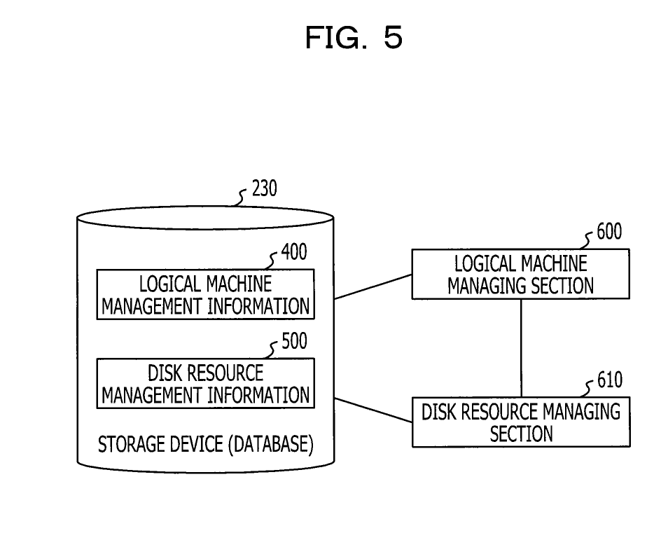

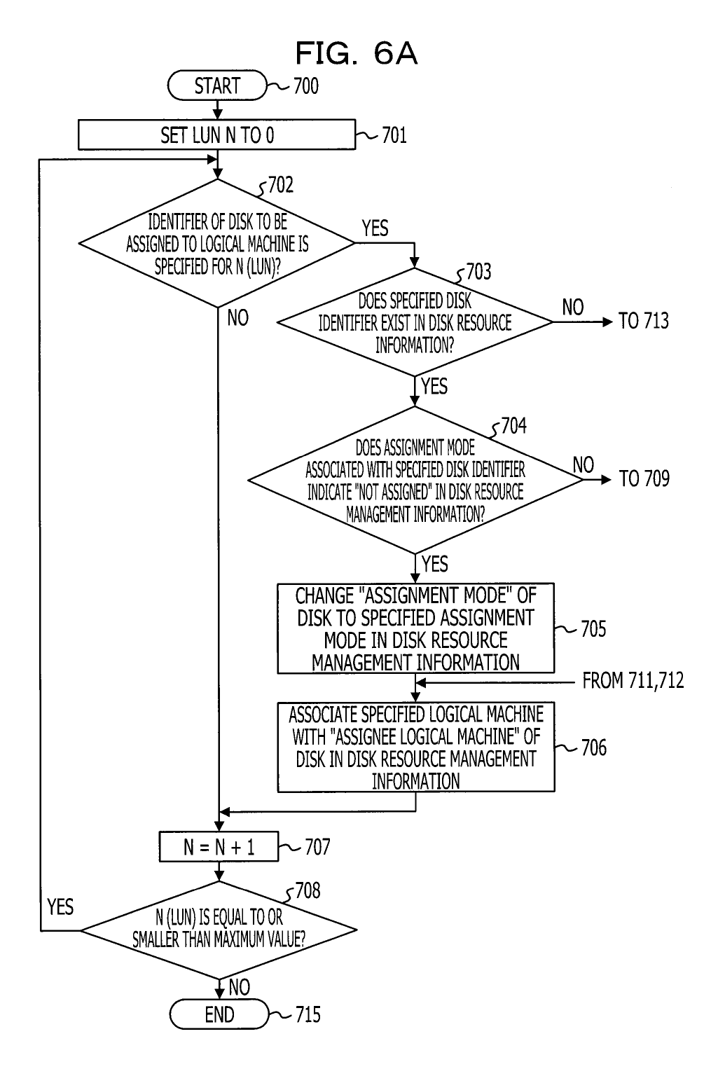

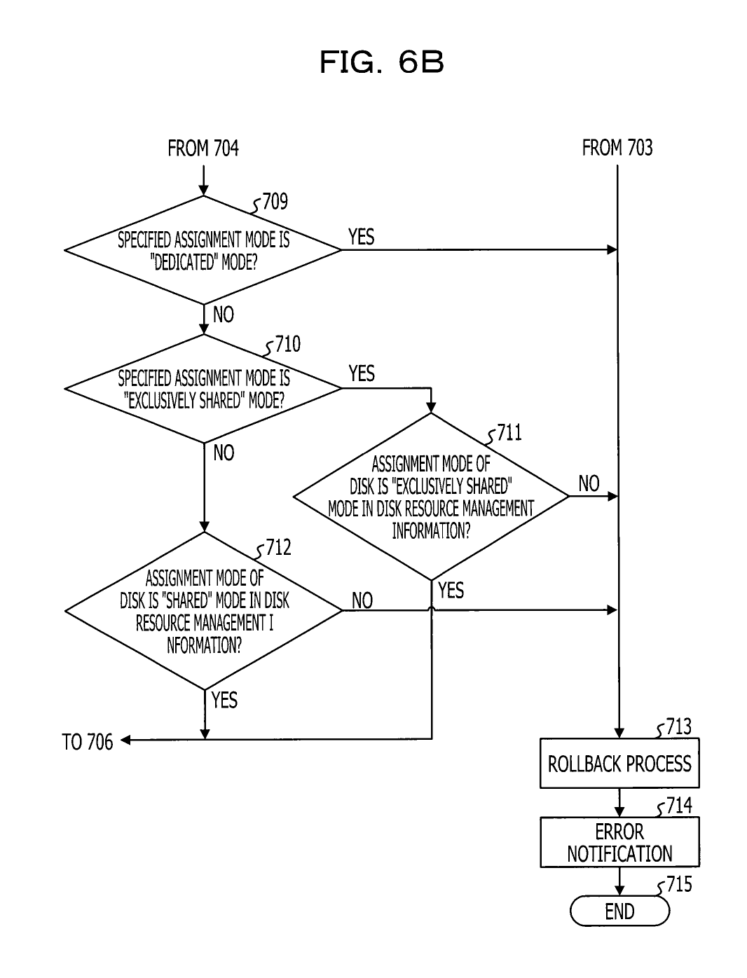

A program in which a process of controlling the infrastructure management server 200 is described, and a program in which processes illustrated in FIGS. 6A, 6B, 7, 8, 9A and 9B are described, are stored in the memory 220. An operation of the infrastructure management server 200 is controlled by causing the CPU 210 to execute the programs stored in the memory 220, and the infrastructure management server 200 functions as functional blocks illustrated in FIG. 5.

The server 310 is a computer that includes a CPU 311, a memory 312, a storage device 313, an NIC 314, and a bus 315. The bus 315 couples the CPU 311, the memory 312, the storage device 313, and the NIC 314 to each other. The CPU 311 includes at least one processor that executes a process. The memory 312 is, for example, a RAM. The NIC 314 is an interface circuit that transmits and receives data to and from an external device. The server 310 communicates with the infrastructure management server 200 and the resource pool 330 through the NIC 314.

A program in which a process of controlling an operation of the server 310 is described, and a program for executing a logical machine in accordance with a resource assigned by the infrastructure management server 200, are stored in the memory 312. An operation of the server 310 is controlled by causing the CPU 312 to execute the programs stored in the memory 312, and a logical machine is executed by the server 310. The server 310 is coupled to a network 350 through the NIC 314 and communicates with a computer coupled to the network 350.

The resource pool 300 includes the server 320. The server 320 has substantially the same configuration as the management target 310, and a description thereof is omitted. Servers to be managed, which are included in the resource pool 300, are not limited to the servers 310 and 320. The resource pool 300 may include only a single server to be managed or include the servers 310 and 320 and one or more other servers to be managed.

The disk resource pool 330 includes disks 331, 332, and 333. The disks 331, 332, and 333 are nonvolatile memories such as ROMs or flash memories or magnetic disk devices such as HDDs. In the embodiment, disks that are included in the disk resource pool 330 are not limited to the disks 331, 332, and 333. The disk resource pool 330 may include only a single disk or include the disks 331, 332, and 333 and one or more other disks.

When receiving information of specifications of a logical machine and a request to assign a physical resource from the service management server 100, the infrastructure management server 200 confirms a usage status of the resource pool 300 managed by the infrastructure management server 200. If the physical resource is enabled to be assigned in accordance with the requested specifications, the physical resource is assigned to the logical machine, and the logical machine is executed on the resource pool 300. Since multiple logical machines are executed on the resource pool 300, the infrastructure administrator adjusts assignments of physical resources based on execution states of logical machines in order to ensure the requested specifications. In addition, the infrastructure administrator causes mirroring of a disk to be executed in order to have redundancy of data to be managed, switches disks, couples a disk, and the like. As described above, the logical machine is executed as a logical server providing a desired service.

The physical resources that are the CPUs and the memories and included in the servers 310 and 320 correspond to the CPU resource pool 61 and the memory resource pool 62, which are described with reference to FIG. 1, while the disk resource pool 330 corresponds to the disk resource pool 63 described with reference to FIG. 1.

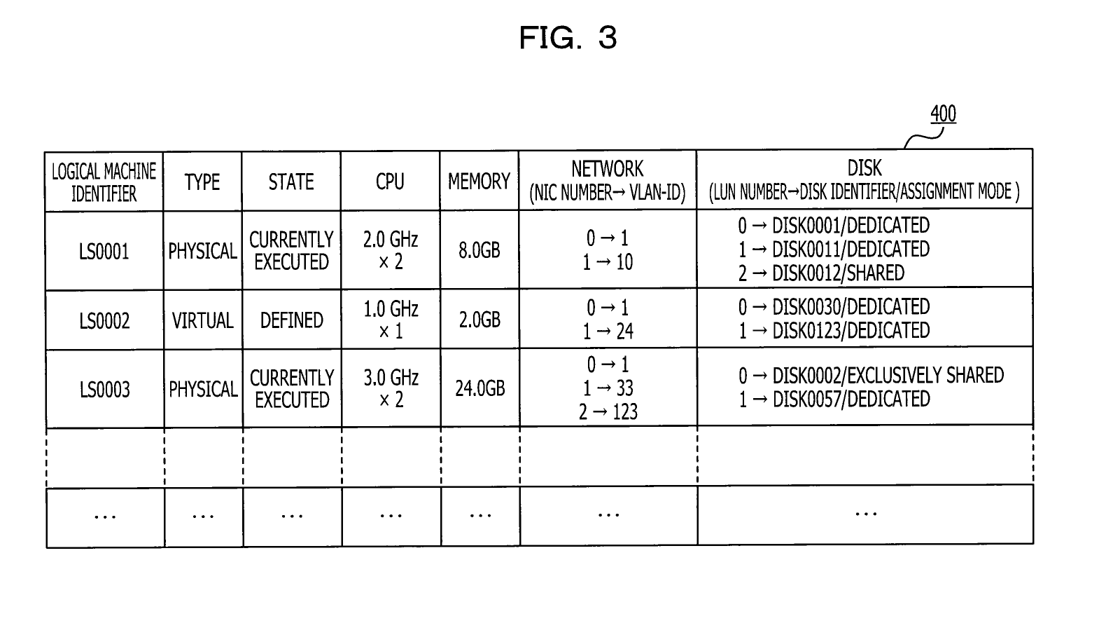

FIG. 3 illustrates logical machine management information 400 to be used by the information processing system to which the embodiment is applicable. In the logical machine management information 400, the identifier of a logical machine, the type of the logical machine, the state of the logical machine, information of a CPU resource assigned to the logical machine, information of a memory resource assigned to the logical machine, information of a network resource assigned to the logical machine, and information of a disk assigned to the logical machine, are associated with each other. The logical machine management information 400 is information that is created or updated by the infrastructure management server 200 based on definition information (for example, the information indicated by reference numerals 20 and 40 of FIG. 1) that is included in a notification provided by the service management server 100 to the infrastructure management server 200 and indicates specifications, defined by the service administrator, of the logical machine. The logical machine management information 400 is stored in the storage device 230 that is used as a database.

The identifier of the logical machine is an identifier that is added by the service administrator and identifies the logical machine. The logical machine that is executed as a logical machine is uniquely identified by the logical machine identifier. The type of the logical machine is information that indicates whether the logical machine is a physical machine or a virtual machine. For example, if the type of the logical machine indicates “physical”, a rack server, a blade server, or the like, which satisfies specifications requested by the server management server 100, is assigned, and the logical machine is executed as a physical machine. If the type of the logical machine indicates “virtual”, a resource that satisfies the specifications requested by the server management servers 100 is assigned, and the logical machine is executed as a virtual machine.

The state of the logical machine indicates whether or not the interested logical machine is executed on the server 310 in response to an activation request from the service management server 100. For example, if the type of the logical machine indicates a “currently executed” state, the logical machine is currently executed on the server 310 in response to the activation request from the service management server 100. If the type of the logical machine indicates a “defined” state, the service management server 100 provides a request to assign a resource to the logical machine, the logical machine is registered in the logical machine management information 400, and the service management server 100 does not provide a request to activate the logical machine, or provides a request to stop the logical machine and the logical machine is not executed on the server 310.

The information of the CPU resource and the information of the memory resource indicate specifications, requested by the service management server 100, of the logical machine. The information of the network resource indicates an association of an NIC number with a virtual local area network (VLAN).

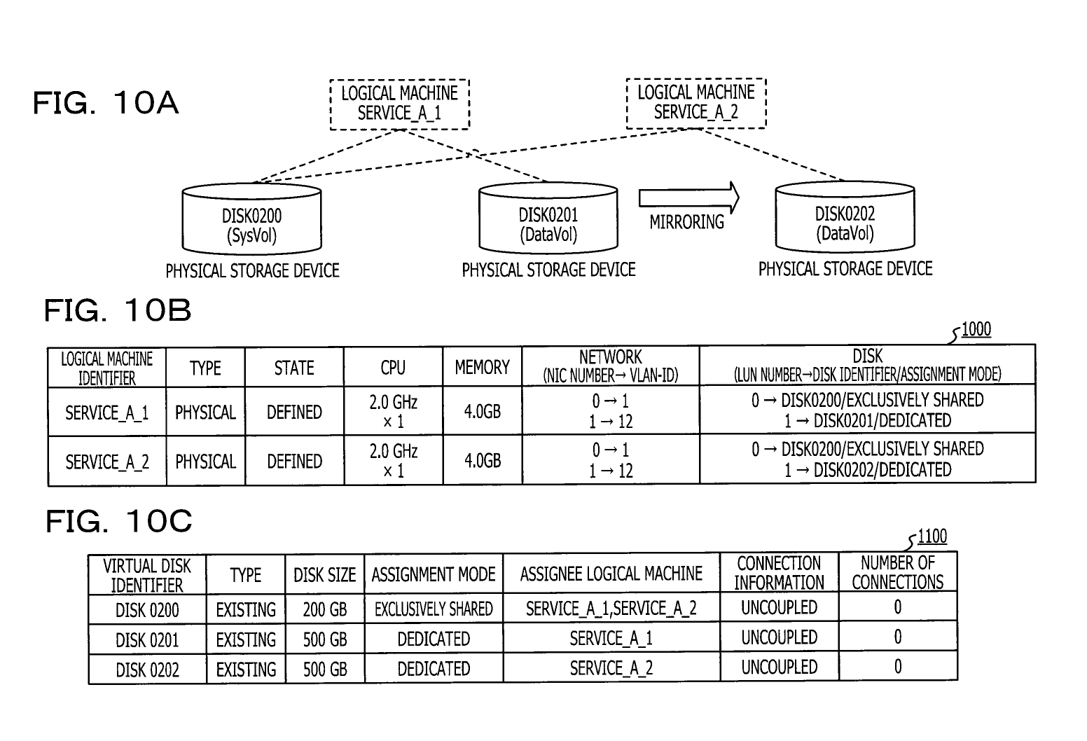

In addition, the logical machine management information 400 indicates a relationship between a logical unit number (LUN) and the identifier of a disk and indicates an assignment mode of the disk. As the assignment mode, a dedicated assignment mode, a shared assignment mode, or an exclusively shared assignment mode is set. If the dedicated assignment mode is set, a specific disk resource is assigned to only a specific logical machine, as described with reference to FIG. 1. If the shared assignment mode is set, a disk resource is assigned to and shared by a plurality of logical machines, as described with reference to FIG. 1. If the exclusively shared assignment mode is set, a plurality of logical machines are associated with a certain disk resource. The certain disk resource, however, is managed so that the plurality of logical machines are not simultaneously coupled to the disk resource. An example in which the exclusively shared assignment mode is applied is described later with reference to FIGS. 10A to 18C (describing examples of mirroring of a disk and examples of a test operation).

FIG. 3 illustrates the case where a logical machine identified by LS0001 belongs to a type of a “physical” machine to which a rack server or a blade server is assigned and the logical machine identified by LS0001 is “currently executed” in response to an activation request from the service management server 100. Two CPUs with a processing speed of “2.0 GHz” and a memory with a capacity of “8.0 Gbytes” are assigned to the logical machine LS0001. A VLAN with an ID “1” is assigned to an NIC with a number “0” and a VLAN with an ID “10” is assigned to an NIC with a number “1” as a network configuration. For assignments of disks to the logical machine LS0001, a disk “Disk0001” is assigned to an LUN “0” in a “dedicated” mode, for example.

In addition, FIG. 3 indicates that a logical machine identified by LS0002 is a “virtual” machine to which a CPU with a processing speed of “1.0 GHz” and a memory with a capacity of “2.0 Gbytes” are assigned. Since the state of the logical machine LS0002 is the “defined” state, an activation request is not provided by the service management server 100, or is provided and the logical machine LS0002 is not executed or waits to be executed. For assignments of disks to the logical machine LS0002, a disk Disk0030 is assigned to the LUN “0” in the “dedicated” mode, for example.

In addition, FIG. 3 indicates that a logical machine identified by LS0003 belongs to the type of the “physical” machine to which a rack server or a blade server is assigned and the logical machine LS0003 is “currently executed” in response to an activation request from the service management server 100. Two CPUs with a processing speed of “3.0 GHz” and a memory with a capacity of “24.0 Gbytes” are assigned to the logical machine LS0003. For an assignment to the logical machine LS0003, a disk “Disk0002” is assigned to the LUN “0” in an “exclusively shared” mode, for example.

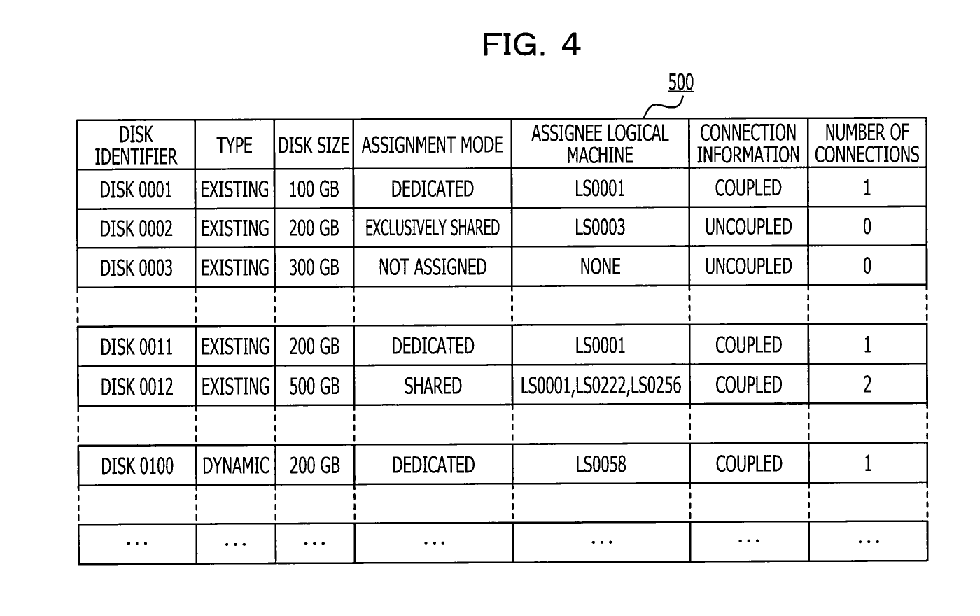

FIG. 4 illustrates disk resource management information 500 to be used by the information processing system to which the embodiment is applicable. In the disk resource management information 500, a disk identifier, a disk type, a disk size, an assignment mode, coupling information, and information of the number of connections are associated with each other. The disk resource management information 500 is stored in the storage device 230 used as the database in the infrastructure management server 200. The disk resource management information 500 is updated by executing any of the processes illustrated in FIGS. 6A to 9B.

The disk identifier is an identifier that is added by the infrastructure management server 200 and identifies a disk. The disk is uniquely identified by the disk identifier. The disk type identifies the type of the disk using a flag indicating “existing” or “dynamic”. If the flag indicates “existing”, the flag means that an LUN that is created in advance by redundant arrays of inexpensive disks (RAID) or a disk resource management product is used by a logical machine. If the flag indicates “dynamic”, the flag means that an LUN is dynamically assigned to a logical machine from a RAID group of a RAID device by the infrastructure management server 200 upon registration of the logical machine.

The disk size indicates the capacity of the disk. The assignment mode indicates the “dedicated” assignment mode, the “shared” assignment mode, the “exclusively shared” assignment mode, or “not assigned”. The disk resource management information 500 also indicates an assignee logical machine. For example, the disk Disk0001 is assigned to the logical machine LS0001 as an assignee logical machine in the dedicated assignment mode, while a disk Disk0012 is assigned to the logical machine LS0001 and logical machines LS0222 and LS0256 in the shared assignment mode. A disk Disk0003 is not assigned to a logical machine, and an assignment mode of the disk Disk0003 indicates “not assigned”.

In FIG. 4, the coupling information that indicates a coupling of the disk to the assignee logical machine is associated with the disk identifier. If the coupling information indicates a “coupled” state, the logical machine is currently coupled to the disk or enabled to be coupled to the disk. If the coupling information indicates an “uncoupled” state, the logical machine is not coupled to the disk or not enabled to be coupled to the disk even if a request for the coupling is provided. In addition, the disk resource management information 500 indicates, as the number of connections, the number of logical machines coupled to the disk. The disk resource management information 500 includes the coupling information that indicates the coupling of the logical machine to the disk, and the infrastructure management server 200 controls the coupling of the logical machine to the disk based on the coupling information.

FIG. 5 illustrates functional blocks that are executed by the infrastructure management server 200 to which the embodiment is applicable. The infrastructure management server 200 functions as a logical machine managing section 600 and a disk resource managing section 610 by causing the CPU 210 to execute the programs stored in the memory 220. The logical machine management information 400 illustrated in FIG. 3 and the disk resource management information 500 illustrated in FIG. 4 are stored in the storage device 230 to be used as the database. Processes that are executed by the functional blocks correspond to the processes illustrated in FIGS. 6A, 6B, 7, 9A and 9B, and are described later.

FIGS. 6A-6B illustrate an example of the process of registering an assignment of a disk to a logical machine by the information processing system to which the embodiment is applicable.

When the service management server 100 transmits definition information of specifications of a logical machine and a request to assign a resource to the logical machine, the infrastructure management server 200 executes a process 700 of starting to check an assignment of a disk to the logical machine. The definition information that is transmitted by the service management server 100 includes information of the identifier of the logical machine, the type of the logical machine, a CPU resource, a memory resource, an assignment of a network resource, an assignment of a disk resource, the capacity of the disk resource, the identifier of the disk, an assignment mode of the disk, and the like, which are requested as the specifications of the logical machine. The definition information is, for example, described using Extensible Markup Language (XML) and is transmitted to the infrastructure management server 200.

When the process illustrated in FIGS. 6A-6B is started, a process 701 of setting an LUN N to 0 is executed by the logical machine managing section 600. In order to check an assignment of a disk for each of LUNs for the disk resource requested by the definition information, an LUN N of “0” is set to be checked. When the process 701 is terminated, the process illustrated in FIGS. 6A-6B proceeds to a process 702.

For the set N (LUN), the process 702 of checking whether or not the definition information specifies the identifier of the disk to be assigned to the logical machine is executed by the logical machine managing section 600.

In the process 702, a disk requested to be assigned to the LUN N by the service management server 100 and whether or not an assignment of the disk is defined are checked based on the definition information. If the logical machine managing section 600 determines that the disk identifier is not specified by the definition information in the process 702, the process illustrated in FIGS. 6A-6B proceeds to a process 707. If the logical machine managing section 600 determines that the disk identifier is specified by the definition information in the process 702, the process illustrated in FIGS. 6A-6B proceeds to a process 703 in order to determine whether or not the disk is enabled to be assigned in accordance with the request provided by the service management server 100.

The process 703 of checking whether or not the disk identifier specified by the definition information exists in the disk resource management information 500 is executed by the logical machine managing section 600. Since disk resources are managed by the infrastructure management server 200, the disk requested by the service management server 100 may be already removed from the resource pool 300 by the infrastructure management server 200. Thus, in the process 703, whether or not the disk requested by the service management server 100 exists in the resource pool 300 is checked by causing the logical machine managing unit 600 to reference the disk resource management information 500 and determine whether or not the disk identifier specified by the definition information transmitted by the service management server 100 exists in the disk resource management information 500. If the logical machine managing section 600 determines that the disk identifier specified by the definition information does not exist in the process 703, the process illustrated in FIGS. 6A-6B proceeds to a rollback process 713. If the logical machine managing section 600 determines that the disk identifier specified by the definition information exists in the process 703, the process illustrated in FIGS. 6A-6B proceeds to a process 704.

The process 704 of determining whether or not an assignment mode associated with the disk identifier specified by the definition information indicates “not assigned” in the disk resource management information 500 is executed by the logical machine managing section 600. If the logical machine managing section 600 determines that the assignment mode does not indicate “not assigned” in the process 704, the process illustrated in FIGS. 6A-6B proceeds to a process 709. If the logical machine managing section 600 determines that the assignment mode indicates “not assigned” in the process 704, the process illustrated in FIGS. 6A-6B proceeds to a process 705.

The process 705 of changing the assignment mode associated with the disk identifier to the assignment mode specified by the definition information in the disk resource management information 500 is executed by the disk resource managing section 610. The process 705 is executed if the logical machine managing section 600 determines that the disk specified by the definition information is not assigned to any logical machine in the process 704. Thus, even if the assignment mode specified by the definition information is any of the assignment modes, the assignment mode specified by the definition information may be set in the disk resource management information 500 in the process 705. When the process 705 is terminated, the process illustrated in FIGS. 6A-6B proceeds to a process 706.

The process 706 of associating the logical machine identifier specified by the definition information with an assignee logical machine associated with the disk identifier specified by the definition information in the disk resource management information 500 is executed by the disk resource managing section 610. The assignee logical machine is associated with the disk by the process 706. When the process 706 is terminated, the process illustrated in FIGS. 6A-6B proceeds to the process 707.

The process 707 of incrementing the LUN N to be checked by 1 is executed by the logical machine managing section 600 in order to check an assignment of a disk for each of LUNs for the disk resource requested by the definition information. The LUN N to be checked is changed by the process 707. When the process 707 is terminated, the process illustrated in FIGS. 6A-6B proceeds to a process 708.

The process 708 of determining whether or not the set N (LUN) is equal to or smaller than the maximum value of LUNs specified by the definition information is executed by the logical machine managing section 600. If the logical machine managing section 600 determines that the set N is equal to or smaller than the maximum value in the process 708, another LUN that is not to be checked may remain, and thus the process illustrated in FIGS. 6A-6B returns to the process 702. If the logical machine managing section 600 determines that the set N is larger than the maximum value in the process 708, all the LUNs are already checked, the process illustrated in FIGS. 6A-6B proceeds to a process 715, and the process executed to check the assignment of the disk to the logical machine is terminated.

If the logical machine managing section 600 determines that the assignment mode does not indicate “not assigned” in the process 704, the process 709 of determining whether or not the assignment mode specified by the definition information is the “dedicated” assignment mode is executed by the logical machine managing section 600. If the logical machine managing section 600 determines that the assignment mode is the “dedicated” assignment mode in the process 709, the logical machine managing section 600 determines that the specified disk is already assigned in the process 704, the disk is not assigned in the “dedicated” assignment mode as indicated by the definition information, and thus the process illustrated in FIGS. 6A-6B proceeds to the rollback process 713 (described later). If the logical machine managing section 600 determines that the assignment mode is not the “dedicated” assignment mode in the process 709, the process illustrated in FIGS. 6A-6B proceeds to a process 710 in order to further check the assignment of the disk.

The process 710 of determining whether or not the assignment mode specified by the definition information is the “exclusively shared” assignment mode is executed by the logical machine managing section 600. If the logical machine managing section 600 determines that the assignment mode is not the “exclusively shared” assignment mode, the process illustrated in FIGS. 6A-6B proceeds to a process 712. If the logical machine managing section 600 determines that the assignment mode is the “exclusively shared” assignment mode, the process illustrated in FIGS. 6A-6B proceeds to a process 711.

The process 711 of determining whether or not the assignment mode associated with the disk identifier specified by the definition information is set as the “exclusively shared” assignment mode in the disk resource management information 500 is executed by the logical machine managing section 600. After the logical machine managing section 600 determines that the disk specified by the definition information is already assigned in the process 704, whether or not the disk is assigned to another logical machine in the “exclusively shared” assignment mode is checked in the process 711. If the logical machine managing section 600 determines that the assignment mode is set as the “exclusively shared” assignment mode in the process 711, the logical machine managing section 600 determines that the disk is enabled to be assigned to the other logical machine (to which the disk is already assigned) and the logical machine specified by the definition information in the “exclusively shared” assignment mode, and the process illustrated in FIGS. 6A-6B proceeds to the process 706. If the disk specified by the definition information is already assigned to the other logical machine in an assignment mode other than the “exclusively shared” assignment mode, the process illustrated in FIGS. 6A-6B proceeds to the rollback process 713 (described later). This is due to the fact that if the disk is assigned in the “exclusively shared” assignment mode, the logical machine competes with the assigned other logical machine.

The process 712 of determining whether or not the assignment mode of the disk specified by the definition information is set as the “shared” assignment mode in the disk resource management information 500 is executed by the logical machine managing section 600. If the logical machine managing section 600 determines that the assignment mode is set as the “shared” assignment mode, the disk is enabled to be assigned as indicated by the definition information, and the process illustrated in FIGS. 6A-6B proceeds to the process 706. If the logical machine managing section 600 determines that the assignment mode is not set as the “shared” assignment mode, the disk is not enabled to be assigned as indicated by the definition information, and the process illustrated in FIGS. 6A-6B proceeds to the rollback process 713 (described later).

The rollback process 713 of releasing the assignment of the disk is executed by the disk resource managing section 610. Even if the disk is successfully assigned to an LUN of the logical machine after the process 700, the disk may not be assigned to another LUN as a result of the processes 713, 709, 710, and 712. In this case, unless associations of assigned disks with logical machines are released, it is determined that the disks are already assigned regardless of the fact that the assignments are unsuccessful, and the disks are not enabled to be used by another logical machine. Thus, the associations of the assigned disks with the logical machines are removed from the disk resource management information 500 by the rollback process 713, and whereby the disk is enabled to be assigned to another logical machine.

After the rollback process 713 is executed, a process 714 of notifying of an error is executed by the disk resource managing section 610. In the process 714, the infrastructure management server 200 notifies the service management server 100 that the disk is not assigned to the logical machine and registration of the logical machine in the logical machine management information 400 fails.

When the series of processes are executed, the process of checking the assignment of the disk to the logical machine is terminated, and the process 715 of notifying the service management server 100 that the registration of the logical machine is completed is executed by the infrastructure management server 200.

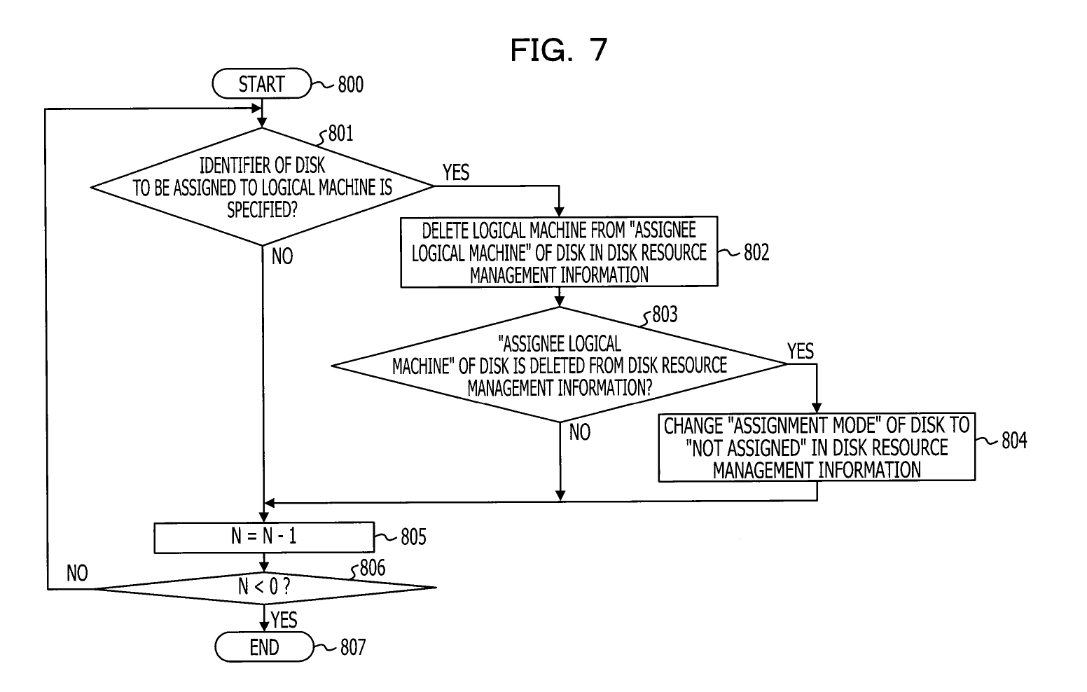

FIG. 7 illustrates an example of the process of releasing an assignment of a disk to a logical machine by the information processing system to which the embodiment is applicable.

When receiving, from the service management server 100, a request to delete a logical machine registered in the logical machine management information 400, the infrastructure management server 200 executes a process 800 of starting the process of releasing an assignment of a disk to the interested logical machine. The process illustrated in FIG. 7 may be applied to the rollback process 713 of deleting a logical machine registered after a failure of an assignment of a disk.

The process 801 of checking whether or not the identifier of the disk assigned to the logical machine to be deleted is associated with the set N (LUN) in the logical machine management information 400 is executed by the logical machine managing section 600. If the disk identifier is not associated, the process illustrated in FIG. 7 proceeds to a process 805. If the disk identifier is associated, the process illustrated in FIG. 7 proceeds to a process 802.

The process 802 of deleting the identifier of the logical machine requested to be deleted by the service management server 100 from an “assignee logical machine” associated to the interested disk identifier is executed by the disk resource managing section 610. The association of the logical machine to be deleted with the assigned disk is released by the process 802.

A process 803 of determining whether or not the assignee logical machine associated with the interested disk identifier is deleted in the disk resource management information 500 is executed by the disk resource managing section 610. If the disk resource managing section 610 determines that the assignee logical machine associated with the interested disk identifier exists, the process illustrated in FIG. 7 proceeds to the process 805. If the disk resource managing section 610 determines that the assignee logical machine associated with the interested disk identifier does not exist, the process illustrated in FIG. 7 proceeds to a process 804.

The process 804 of changing an assignment mode associated with the interested disk identifier to “not assigned” in the disk resource management information 500 is executed by the disk resource managing section 610.

The process 805 of changing the set LUN is executed by the logical machine managing section 600 in order to check a disk assigned to another LUN of the logical machine requested to be deleted by the service management server 100. In the process 805, the LUN N is reduced by 1, for example.

A process 806 of determining whether or not disks for all LUNs of the logical machine requested to be deleted by the service management server 100 have been checked is executed by the logical machine managing section 600. For example, if the LUN N is reduced by 1 in the process 805, the logical machine managing section 600 determines whether or not the LUN N is a negative number in the process 806. If the logical machine managing section 600 determines that any of the disks for all the LUNs of the logical machine to be deleted is yet to be checked, the process illustrated in FIG. 7 returns to the process 801. If the logical machine managing section 600 determines that the disks for all the LUNs of the logical machine to be deleted have been checked, the process illustrated in FIG. 7 proceeds to a process 807.

When the series of processes are executed, the process 807 of terminating the process of releasing an assignment of a disk to the logical machine is executed by the infrastructure management server 200.

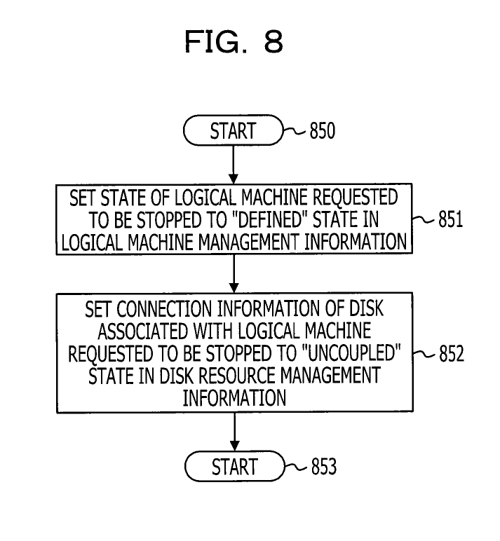

FIG. 8 illustrates an example of the process of setting coupling information of a disk to an “uncoupled” state by the information processing system to which the embodiment is applicable. When receiving a request to stop a logical machine from the service management server 100, the infrastructure management server 200 starts a process illustrated in FIG. 8.

A process 851 of setting a state of a logical machine requested to be stopped to the “defined” state in the logical machine management information 400 is executed by the logical machine managing section 600. Although information of the logical machine requested to be stopped is left in the logical machine management information 400 by the process 851, the logical machine is not executed on the cloud platform.

A process 852 of setting coupling information of a disk associated with the logical machine requested to be stopped to the “uncoupled” state in the disk resource management information 500 is executed by the disk resource managing section 610. In the process 852, the coupling information of the disk coupled to the logical machine is updated to the “uncoupled” state, and the coupling of the logical machine to the disk is released. If the coupling information indicates the “uncoupled” state and the logical machine to which the disk of which the coupling information is updated to the “uncoupled” state is assigned is requested to be activated, the coupling of the logical machine requested to be activated to the disk is permitted. In the embodiment, when a specific process is executed so as to update the coupling information as the “uncoupled” state from the “uncoupled” state, the coupling information may be set to the “uncoupled” state.

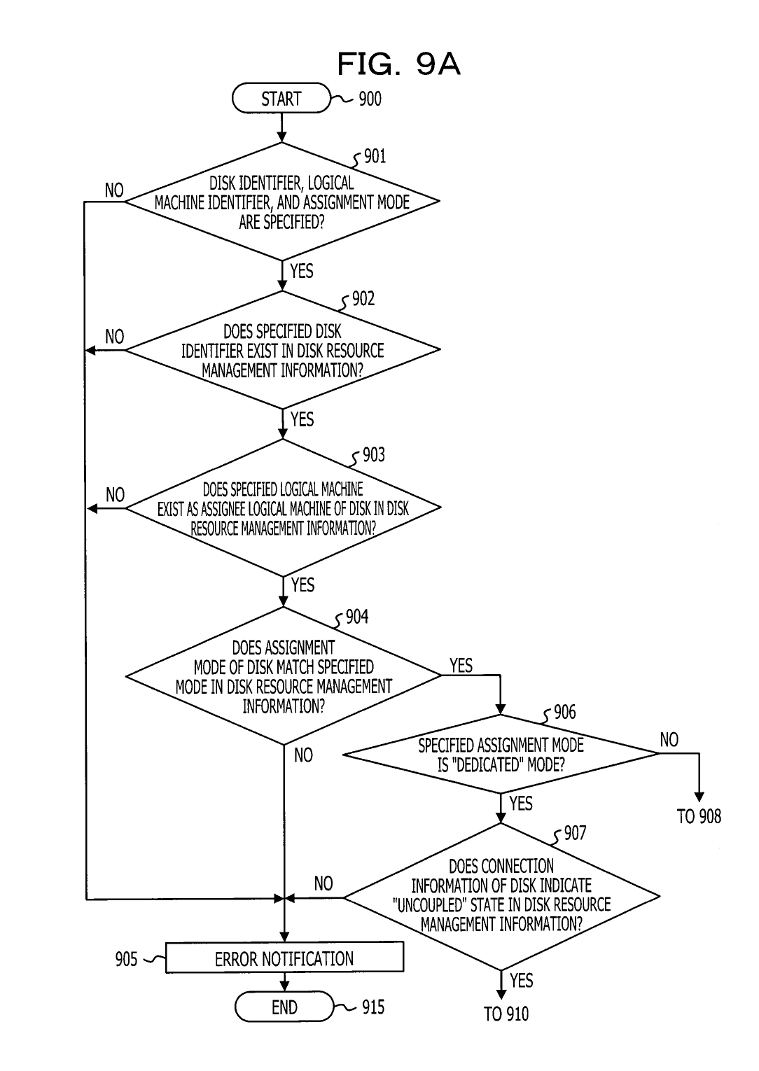

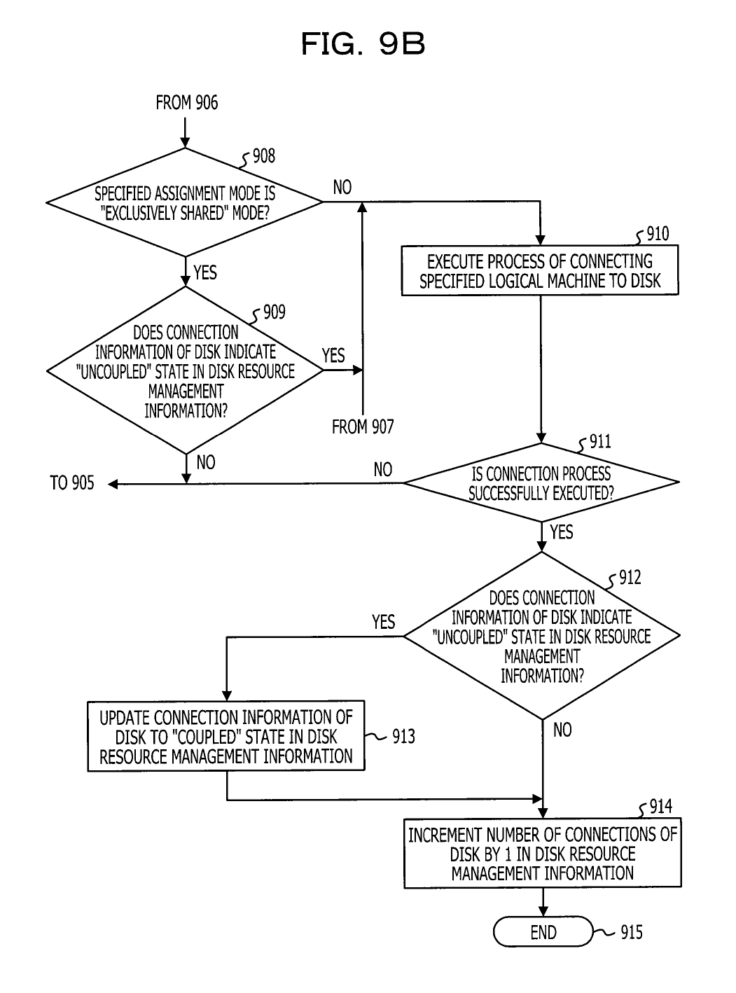

FIGS. 9A-9B illustrate an example of the process of coupling a logical machine to a disk by the information processing system to which the embodiment is applicable. The process illustrated in FIGS. 9A-9B is a process of coupling a logical machine to a disk associated with the logical machine when the logical machine is registered in the logical machine management information 400 by the process illustrated in FIGS. 6A-6B, an assignment of the disk to the logical machine is associated in the disk resource management information 500, and the infrastructure management server 200 receives a request to start activating the logical machine from the service management server 100. When receiving, from the service management server 100, the request to start activating the logical machine, the infrastructure management server 200 executes a process 900 of starting the process illustrated in FIGS. 9A-9B.

A process 901 of checking the state of the assignment of the disk to the logical machine requested to be activated is executed by the logical machine managing section 600. In the process 901, the logical machine managing section 600 references the logical machine management information 400 and checks whether or not a disk identifier, a logical machine identifier, and an assignment mode are associated with each other for the logical machine requested to be activated. The process 901 is executed in order to check whether or not information on the logical machine to be activated has an inconsistency due to a power failure, a system failure, or the like. If the logical machine managing section 600 determines that the logical machine management information 400 has an inconsistency, the process illustrated in FIGS. 9A-9B proceeds to a process 905. If the logical machine managing section 600 determines that the logical machine requested to be activated is normally registered in the logical machine management information 400, the process illustrated in FIGS. 9A-9B proceeds to a process 902.

The process 902 of checking whether or not the identifier of a disk associated with the logical machine to be activated exists in the disk resource management information 500 is executed by the disk resource managing section 610. In the process 902, the disk resource managing section 610 checks whether or not an assignment of the disk has an inconsistency on the assumption that the disk is temporarily assigned to the logical machine by the process illustrated in FIGS. 6A-6B and removed from the disk resource pool 330. If the disk resource managing section 610 determines that the disk identifier does not exist, the process illustrated in FIGS. 9A-9B proceeds to the process 905. If the disk resource managing section 610 determines that the disk identifier exists, the process illustrated in FIGS. 9A-9B proceeds to a process 903.

The process 903 of checking whether or not the logical machine to be activated is associated with an assignee logical machine associated with the disk identifier checked in the process 902 is executed by the disk resource managing section 610. The process 903 is executed in order to check whether or not the information on the logical machine to be activated has an inconsistency due to a power failure, a system failure, or the like. If the disk resource managing section 610 determines that the logical machine to be activated is not associated, the process illustrated in FIGS. 9A-9B proceeds to the process 905. If the disk resource managing section 610 determines that the logical machine to be activated is associated, the process illustrated in FIGS. 9A-9B proceeds to a process 904.

The process 904 of checking whether or not an assignment mode associated with the disk identifier checked in the process 902 matches an assignment mode requested, as a specification, for the logical machine to be activated is executed by the disk resource managing section 610. The process 904 is executed in order to check whether or not the information on the logical machine to be activated has an inconsistency due to a power failure, a system failure, or the like. If the disk resource managing section 610 determines that the assignment modes match, the process illustrated in FIGS. 9A-9B proceeds to a process 906. If the disk resource managing section 610 determines that the assignment modes do not match, the process illustrated in FIGS. 9A-9B proceeds to the process 905.

The process 905 of notifying of an error is executed by the infrastructure management server 200. In the process 905, the infrastructure management server 200 notifies the service management server 100 that activation of the logical machine requested to be activated has failed since the checking of the process 901, 902, 903, or 904 is not normally terminated. In the process 905, the infrastructure management server 200 may notify the service management server 100 of a checking process that is not normally terminated.

The process 906 of determining whether or not the assignment mode of the logical machine to be activated is the “dedicated” assignment mode based on the logical machine management information 400 is executed by the logical machine managing section 600. If the logical machine managing section 600 determines that the assignment mode of the logical machine to be activated is not the “dedicated” assignment mode, the process illustrated in FIGS. 9A-9B proceeds to a process 908. If the logical machine managing section 600 determines that the assignment mode of the logical machine to be activated is the “dedicated” assignment mode, the process illustrated in FIGS. 9A-9B proceeds to a process 907.

The process 907 of determining whether or not coupling information of a disk assigned to the logical machine to be activated indicates the “uncoupled” state in the disk resource management information 500 is executed by the disk resource managing section 610. The process 907 is executed after the logical machine managing section 600 determines that the assignment mode of the logical machine to be activated is the “dedicated” assignment mode. If the disk resource managing section 610 determines that the coupling information of the disk does not indicate the “uncoupled” state in the process 907, another logical machine may be coupled to the disk and the logical machine to be activated is not enabled to be coupled to the disk in the “dedicated” assignment mode regardless of the fact that the assignment mode of the logical machine to be activated is the “dedicated” assignment mode. Thus, if the disk resource managing section 610 determines that the assignment mode of the logical machine to be activated is not the “dedicated” assignment mode, the process illustrated in FIGS. 9A-9B proceeds to the process 905 and the infrastructure management server 200 notifies the service management server 100 of an error. If the disk resource managing section 610 determines that the assignment mode of the logical machine to be activated is the “dedicated” assignment mode, the logical machine to be activated is enabled to be coupled to the disk in the “dedicated” assignment mode, and the process illustrated in FIGS. 9A-9B proceeds to a process 910.

The process 908 of determining whether or not the assignment mode of the logical machine to be activated is the “exclusively shared” assignment mode in the logical machine management information 400 is executed by the logical machine managing section 600. The process 908 is executed after the logical machine managing section 600 determines that the assignment mode of the logical machine to be activated is not the “dedicated” assignment mode in the process 906. If the logical machine managing section 600 determines that the assignment mode of the logical machine to be activated is not the “exclusively shared” assignment mode in the process 908, the checking processes 901 to 904 have been normally terminated, and the assignment mode of the logical machine to be activated is the “shared” assignment mode. If the logical machine managing section 600 determines that the assignment mode of the logical machine to be activated is not the “exclusively shared” assignment mode in the process 908, the process illustrated in FIGS. 9A-9B proceeds to the process 910 in order to couple the logical machine to be activated to the disk in the “shared” assignment mode. If the logical machine managing section 600 determines that the assignment mode of the logical machine to be activated is the “exclusively shared” assignment mode, the process illustrated in FIGS. 9A-9B proceeds to a process 909 in order to change the content of the coupling process based on the coupling information of the disk to be coupled.

The process 909 of determining whether or not the coupling information of the disk associated with the logical machine to be activated indicates the “uncoupled” state in the disk resource management information 500 is executed by the disk resource managing section 610. If the disk resource managing section 610 determines that the coupling information of the disk indicates the “uncoupled” state, the logical machine to be activated is enabled to be coupled to the disk in the “exclusively shared” assignment mode, and the process illustrated in FIGS. 9A-9B proceeds to the process 910. If the disk resource managing section 610 determines that the coupling information of the disk does not indicate the “uncoupled” state, the logical machine is not coupled to the disk and activated, and the process illustrated in FIGS. 9A-9B proceeds to the process 905 so as to notify the service management server 100 of an error.

In the embodiment, if a request to activate a logical machine to which a disk of which an assignment mode is set to the “exclusively shared” assignment mode is assigned in the disk resource management information 500 is provided, and another logical machine is coupled to the disk, the coupling information of the disk is set to the “coupled” state and whereby the logical machine requested to be activated is not coupled to the disk and activated.

As described with reference to FIG. 8, in the embodiment, if a request to stop the other logical machine is provided by the service management server 100, the state of the other logical machine is the “defined” state in the logical machine management information 400 in the database of the infrastructure management server 200, and the coupling of the other logical machine to the disk is released by setting the coupling information of the disk to the “uncoupled” state in the disk resource management information 500. If the coupling information indicates the “uncoupled” state and the request to activate the logical machine to which the disk is assigned is provided, the process illustrated in FIGS. 9A-9B proceeds from the process 909 to the process 910, and the logical machine to be activated is coupled to the disk and activated.

The process 910 of coupling the logical machine to be activated to the disk in the assignment mode specified by the disk resource management information 500 is executed by the disk resource managing section 610. In the process 910, the logical machine to be activated is coupled to the disk and activated.

The process 911 of determining whether or not the coupling process 910 is successfully executed is executed by the disk resource managing section 610. If the disk resource managing section 610 determines that the coupling process 910 is not successfully executed, the process illustrated in FIGS. 9A-9B proceeds to the process 905. If the disk resource managing section 610 determines that the coupling process 910 is successfully executed, the process illustrated in FIGS. 9A-9B proceeds to a process 912.

The process 912 of determining whether or not the coupling information of the disk associated with the logical machine to be activated indicates the “uncoupled” state in the disk resource management information 500 is executed by the disk resource managing section 610. If the disk resource managing section 610 determines that the coupling information does not indicate the “uncoupled” state, the process illustrated in FIGS. 9A-9B proceeds to a process 914. If the disk resource managing section 610 determines that the coupling information indicates the “uncoupled” state, a process 913 of updating the coupling information of the disk associated with the logical machine to be activated to the “coupled” state in the disk resource management information 500 is executed by the disk resource managing section 610, and the process illustrated in FIGS. 9A-9B proceeds to a process 914.

The process 914 of changing the “number of connections” of the disk associated with the logical machine to be activated in the disk resource management information 500 is executed by the disk resource managing section 610. In the process 914, the disk resource managing section 610 monitors information of the number of connections to the disk and may make various processing determinations for the disk.

A process 915 of terminating the process of coupling the logical machine to the associated disk is executed by the infrastructure management server 200.

In the embodiment, an assignment of a disk in the “exclusively shared” assignment mode is approved by the infrastructure management server 200 and registered in the disk resource management information 500 as described above. Then, any of logical machines is activated based on coupling information of disks in the disk resource management information 500 in response to switching between activation and stop of a logical machine by the service management server 100. For example, when a request to couple a logical machine to a disk is provided in response to a request to activate the logical machine, and coupling information of the disk indicates the “coupled” state in the disk resource management information 500, an exclusive coupling to the disk is ensured by causing the logical machine (requested to be activated) not to be activated. In addition, if a logical machine coupled to the disk in the exclusively shared mode already exists, the coupling information of the disk is set to the “uncoupled” state in the disk resource management information 500 by causing the service management server 100 to temporarily stop the coupled logical machine. Then, when the service management server 100 provides, to the infrastructure management server 200, a request to activate another logical machine that has been registered in the disk resource management information 500 and for which the exclusively shared assignment mode has been set, the other logical machine is coupled to the disk in the exclusively shared mode and activated.

As described above, in the embodiment, since an assignment of a disk to a logical machine is switched based on switching between activation and stop of the logical machine by the service management server 100, the disk may be switched without approval of the infrastructure management server 200.

In cloud computing, a resource of a logical machine to be executed is basically managed by the infrastructure management server 200. Specifically, if specifications of the logical machine are satisfied, an assignment of a resource from the resource pool 300 is managed by an operation of the infrastructure management server 200. If the operational management is executed, and a logical machine coupled exclusively to a disk is stopped due to an error or the like, the coupling of the logical machine to the disk included in the resource pool 300 is released under the authority of the infrastructure management server 200. Thus, the service management server 100 waits for the infrastructure management server 200 to release the disk in order to restart the service. According to the embodiment, however, the service management server 100 that activates and stops the logical machine may release the disk and switch the disk even if support is not quickly provided regardless of the fact that the release process is to be executed by the infrastructure management server 200 managing the cloud platform, and whereby the service management server 100 may quickly restart the service.

FIGS. 10A to 10C illustrate an application example of the embodiment. As illustrated in FIG. 10A, it is assumed that a disk Disk0200 storing a system file and a disk Disk0201 storing data are assigned to a logical machine SERVICE_A_{—}1 (as indicated by dotted lines), while the disk Disk0200 and a disk Disk0202 storing data obtained by mirroring the data stored in the disk Disk0201 in order to have redundancy are assigned to a logical machine SERVICE_A_{—}2 (as indicated by dotted lines). The service management server 100 requests the infrastructure management server 200 to assign specifications of the system illustrated in FIG. 10A, the infrastructure management server 200 assigns the specifications from the cloud platform (servers 310 and 320 and disk resource pool 330) managed by the infrastructure management server 200, and whereby the service that uses the cloud platform is provided. It is assumed that the disks Disk0200, Disk0201, and Disk0202 are different physical disks.

The mirroring of the data stored in the disk Disk0201 into the disk Disk0202 is executed by the infrastructure management server 200 that manages the cloud platform. If the disk Disk0201 fails, disk chassis failover is executed to couple the logical machine SERVICE_A_{—}1 to the disk Disk0202 storing the mirrored data. In order to recover access to the disk Disk0201 from the logical machine SERVICE_A_{—}1, the disk Disk0201 is switched under the authority of the infrastructure management server 200 that manages the disks Disk0201 and Disk0202. Thus, the disk chassis failover is not executed only under the authority of the service management server 100.

FIG. 10B illustrates logical machine management information 1000 corresponding to the system illustrated in FIG. 10A. The assignments of the resources to the logical machines SERVICE_A_{—}1 and SERVICE_A_{—}2 are requested by the service management server 100, the process illustrated in FIGS. 6A-6B is executed by the infrastructure management server 200, and whereby the logical machine management information 1000 illustrated in FIG. 10B is created and stored in the database of the infrastructure management server 200.

The disk Disk0200 is assigned to the logical machine SERVICE_A_{—}1 in the exclusively shared assignment mode, and the disk Disk0201 is assigned to the logical machine SERVICE_A_{—}1 in the dedicated assignment mode. The disk Disk0200 is assigned to the logical machine SERVICE_A_{—}2 in the exclusively shared assignment mode, and the disk Disk0202 is assigned to the logical machine SERVICE_A_{—}2 in the dedicated assignment mode. In the state illustrated in FIG. 10A, the states of the logical machines SERVICE_A_{—}1 and SERVICE_A_{—}2 are only “defined” in the infrastructure management server 200 and are not activated and coupled to the disks Disk0201 and Disk0202.

FIG. 10C illustrates disk resource management information 1100 corresponding to the system illustrated in FIG. 10A. The assignments of the resources to the logical machines SERVICE_A_{—}1 and SERVICE_A_{—}2 are requested by the service management server 100, the process illustrated in FIGS. 6A-6B is executed by the infrastructure management server 200, and whereby the disk resource management information 1100 illustrated in FIG. 10C is created and stored in the database of the infrastructure management server 200. The disk Disk0200 is associated with the exclusively shared assignment mode and the logical machines SERVICE_A_{—}1 and SERVICE_A_{—}2 as assignee logical machines. The disk Disk0201 is associated with the dedicated assignment mode and the logical machine SERVICE_A_{—}1 as an assignee logical machine. The disk Disk0202 is associated with the dedicated assignment mode and the logical machine SERVICE_A_{—}2 as an assignee logical machine. As described above, the logical machines SERVICE_A_{—}1 and SERVICE_A_{—}2 are only defined and are not activated. Specifically, the process illustrated in FIGS. 9A-9B is not executed, and thus the coupling information of all the disks Disk0200, Disk0201, and Disk0202 indicates the uncoupled state.

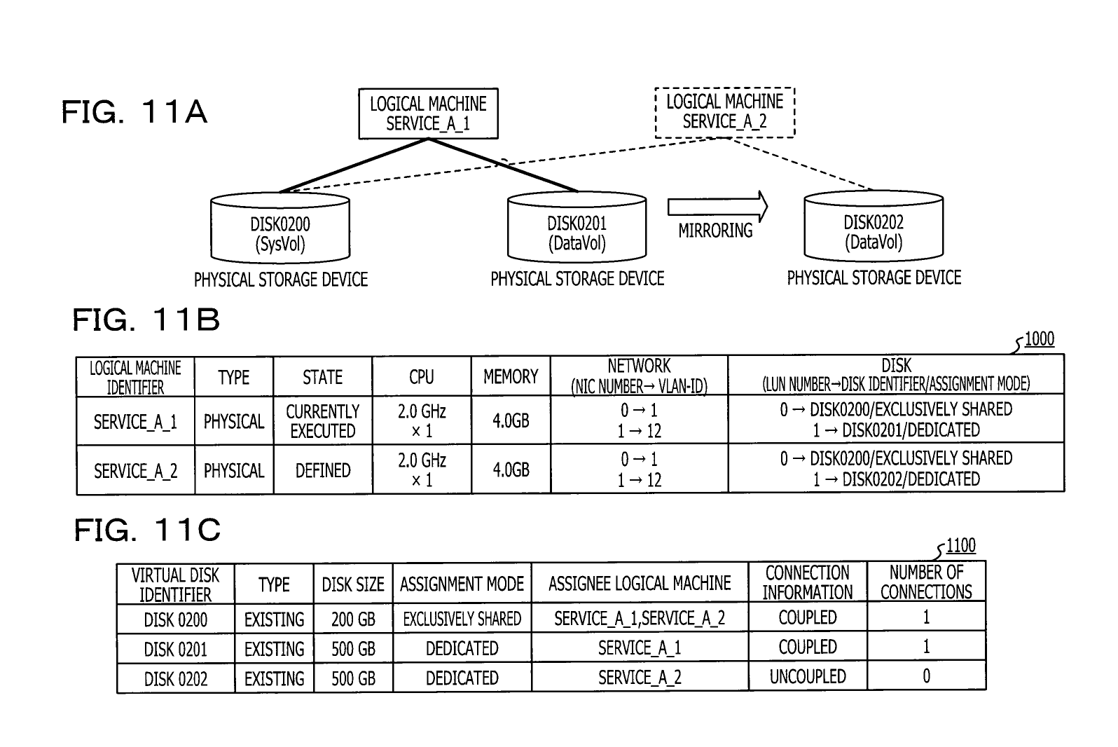

FIGS. 11A to 11C illustrate an example in which the service is provided by the logical machine SERVICE_A_{—}1. In the example illustrated in FIGS. 11A to 11C, the service management server 100 requests the infrastructure management server 200 to activate the logical machine SERVICE_A_{—}1, and the logical machine SERVICE_A_{—}1 is executed. As illustrated in FIG. 11A, the logical machine SERVICE_A_{—}1 is coupled to the disks Disk0200 and Disk0201 (as indicated by solid lines).

FIG. 11B illustrates the logical machine management information 1000 corresponding to the system illustrated in FIG. 11A. The logical machine management information 1000 is created based on the process illustrated in FIGS. 6A-6B and stored in the database of the infrastructure management server 200. The difference between the logical machine management information 1000 illustrated in FIG. 11B and the logical machine management information 1000 illustrated in FIG. 10B is that the state of the logical machine SERVICE_A_{—}1 is the “currently executed” state since the logical machine SERVICE_A_{—}1 is executed.

FIG. 11C illustrates the disk resource management information 1100 corresponding to the system illustrated in FIG. 11A. The disk resource management information 1100 is created based on the process illustrated in FIGS. 6A-6B and stored in the database of the infrastructure management server 200. The disk Disk0200 is assigned to the logical machines SERVICE_A_{—}1 and SERVICE_A_{—}2 in the exclusively shared assignment mode. The logical machine SERVICE_A_{—}1 is activated in response to the activation request provided by the service management server 100 and is coupled to the disk Disk0200, while the logical machine SERVICE_A_{—}2 is not coupled to the disk Disk0200. Since the logical machine SERVICE_A_{—}1 is coupled to the disk Disk0200, the coupling information of the disk Disk0200 indicates the “coupled” state in the disk resource management information 1100. In this case, the logical machine SERVICE_A_{—}1 reads and writes the system file from and in the disk Disk0200, and the logical machine SERVICE_A_{—}2 does not overwrite the system file.

Since the logical machine SERVICE_A_{—}1 is coupled to the disk Disk0201 in the dedicated assignment mode, the coupling information of the disk Disk0201 indicates the “coupled” state in the disk resource management information 1100. The disk Disk0202 is assigned to the logical machine SERVICE_A_{—}2 in the dedicated assignment mode. The disk Disk0202 is a backup disk for the case where an error occurs to the disk Disk0201. The logical machine SERVICE_A_{—}2 is a backup logical machine. Thus, the logical machine SERVICE_A_{—}2 is not activated and coupled to the disk Disk0202 until the service management server 100 provides an activation request. Specifically, the disk Disk0202 is only assigned to the logical machine SERVICE_A_{—}2 and not coupled to the logical machine SERVICE_A_{—}2, and thus the logical machine SERVICE_A_{—}2 does not read and write data from and in the disk Disk0202.

The case where the service management server 100 transmits a request to activate the logical machine SERVICE_A_{—}2 to the infrastructure management server 200 is described below. When the service management server 100 transmits the request to activate the logical machine SERVICE_A_{—}2 to the infrastructure management server 200, the infrastructure management server 200 executes the process illustrated in FIGS. 9A-9B as a process of coupling the logical machine SERVICE_A_{—}2 to a disk. The logical machine SERVICE_A_{—}2 tries to be coupled to the disk Disk0200 in the exclusively shared assignment mode. The logical machine SERVICE_A_{—}1, however, is already coupled to the disk Disk0200, and the coupling information of the disk Disk0200 indicates the “coupled” state and does not indicate the “uncoupled” state in the disk resource management information 1100. Thus, the coupling fails in the process 909 illustrated in FIGS. 9A-9B. As a result, the infrastructure management server 200 notifies the service management server 100 of an error in the process 905, the logical machine SERVICE_A_{—}2 is not coupled to the disk Disk0200 and activated.

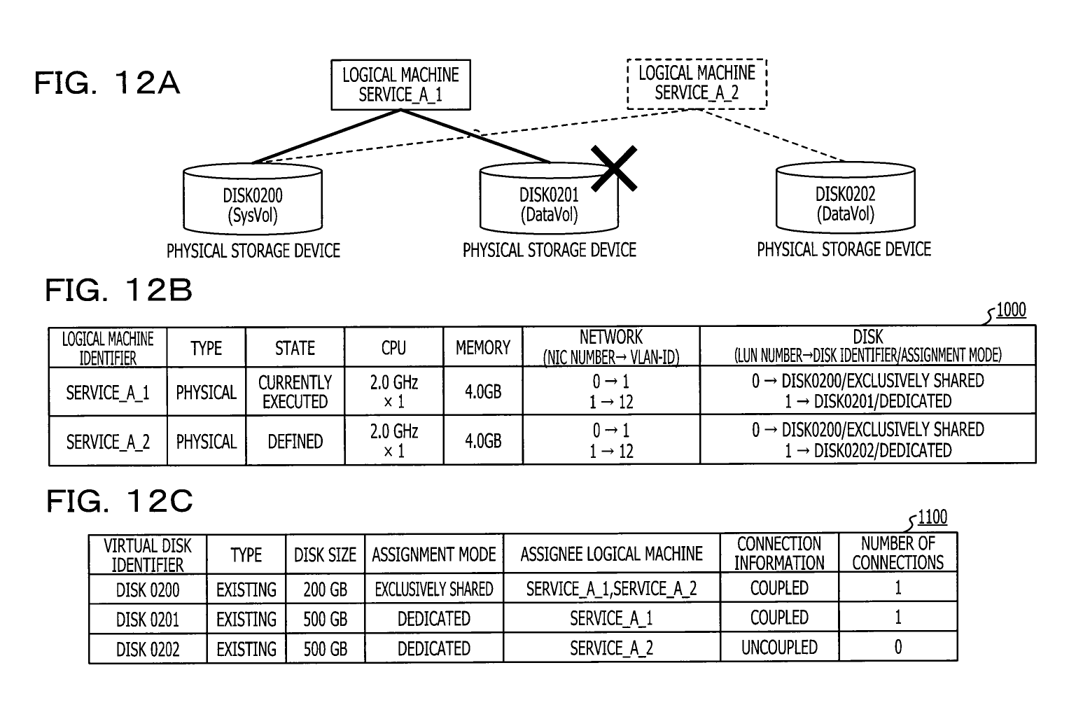

FIGS. 12A to 12C illustrate an example in which a disk that stores data fails. FIG. 12A illustrates an example of a system in which the disk Disk0201 fails and the logical machine SERVICE_A_{—}1 is not coupled to the disk Disk0201. In this case, the service management server 100 does not provide the service using the logical machine SERVICE_A_{—}1. In the state illustrated in FIG. 12A, the logical machine management information 1000 illustrated in FIG. 12B is the same as the information illustrated in FIG. 11B, and the disk resource management information 1100 illustrated in FIG. 12C is the same as the information illustrated in FIG. 11C.

The logical machine SERVICE_A_{—}2 is a backup logical machine for the logical machine SERVICE_A_{—}1 and enabled to be coupled to the mirrored backup disk Disk0202. In order to execute the logical machine SERVICE_A_{—}2 as a backup logical machine, system information, stored in the disk Disk0200, of the logical machine SERVICE_A_{—}1 is used. As described with reference to FIGS. 11A to 11C, the coupling information of the disk Disk0200 indicates the “coupled” state, and the logical machine SERVICE_A_{—}2 is not coupled to the disk Disk0200 and executed as a backup logical machine. In the embodiment, a process of releasing a coupling of a logical machine to a disk is executed based on an instruction of the service management server 100, and a process of coupling a logical machine exclusively to a disk is executed based on an instruction of the service management server 100.

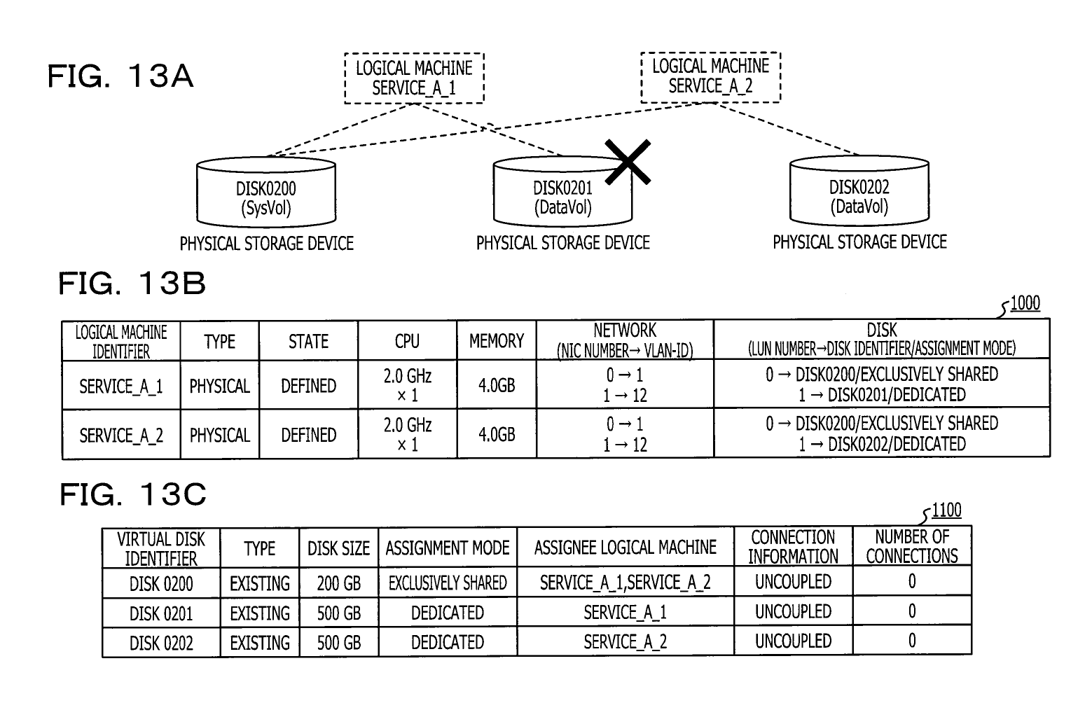

FIGS. 13A to 13C illustrates an example in which the connections of the logical machine SERVICE_A_{—}1 to the disks are released. FIG. 13A illustrates the example in which the service management server 100 transmits a request to stop the logical machine SERVICE_A_{—}1 to the infrastructure management server 200 and the connections of the logical machine SERVICE_A_{—}1 to the disks Disk0200 and Disk0201 are released (as indicated by dotted lines). In this example, the disk Disk0201 fails, and the mirroring of the data into the disk Disk0202 is stopped.

FIG. 13B illustrates the logical machine management information 1000 corresponding to the system illustrated in FIG. 13A. In the logical machine management information 1000 illustrated in FIG. 13B, the state of the logical machine SERVICE_A_{—}1 is updated to the “defined” state. As described above, according to the embodiment, the service management server 100 provides a request to stop the logical machine SERVICE_A_{—}1, and whereby the state of the logical machine SERVICE_A_{—}1 is updated from the “currently executed” state to the “defined” state in the logical machine management information 100 managed by the infrastructure management server 200.

FIG. 13C illustrates the disk resource management information 1100 corresponding to the system illustrated in FIG. 13A. In FIG. 13C, the coupling information of the disks Disk0200 and Disk0201 are updated to the “uncoupled” state. According to the embodiment, the state of the logical machine SERVICE_A_{—}1 is set to the “defined” state based on the request to stop the logical machine SERVICE_A_{—}1 from the service management server 100, and whereby the coupling information of the disk Disk0200 is switched to the “uncoupled” state in the disk resource management information 1100 managed by the infrastructure management server 200. Specifically, the coupling of the logical machine SERVICE_A_{—}1 to the disk Disk0200 may be released by the service management server 100. In addition, the state of the logical machine SERVICE_A_{—}1 is set to the “defined” state based on the request to stop the logical machine SERVICE_A_{—}1 from the service management server 100, and whereby the coupling information of the disk Disk0201 is switched to the “uncoupled” state in the disk resource management information 1100 managed by the infrastructure management server 200. Specifically, the coupling of the logical machine SERVICE_A_{—}1 to the failed disk Disk0201 may be released by the service management server 100.

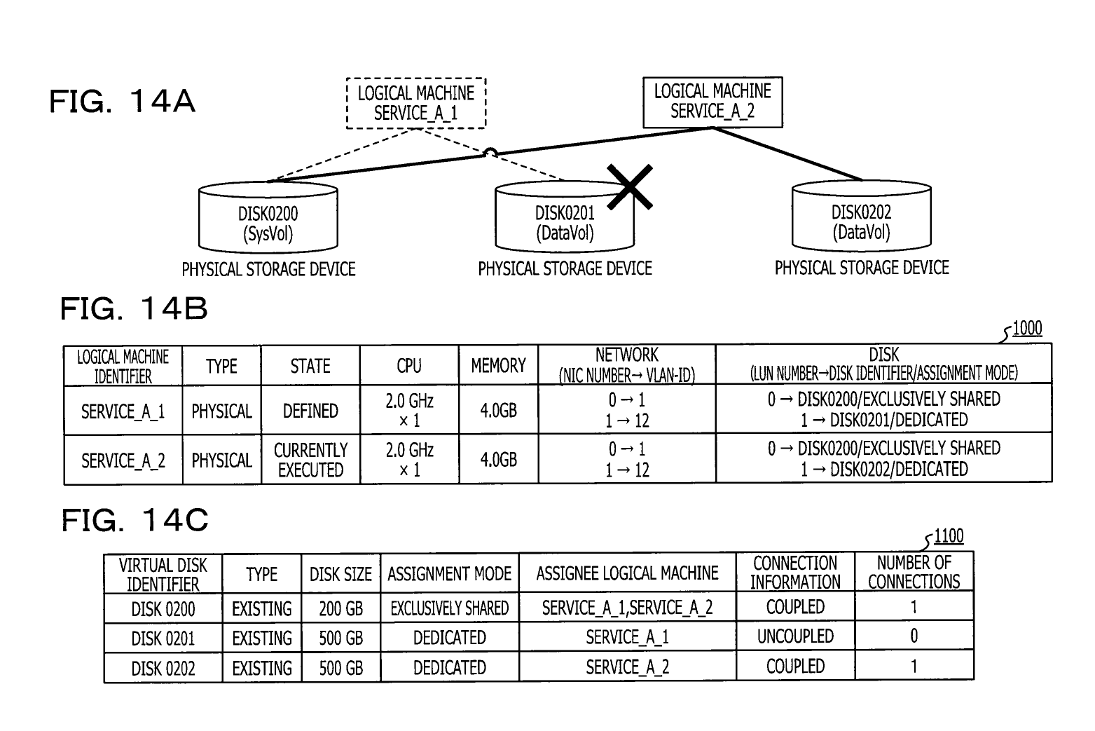

FIGS. 14A to 14C illustrate an example in which the backup logical machine SERVICE_A_{—}2 is coupled to the disks in the exclusively shared assignment mode. FIG. 14A illustrates that the service management server 100 transmits a request to activate the logical machine SERVICE_A_{—}2 to the infrastructure management server 200, and whereby the logical machine SERVICE_A_{—}2 is coupled to the disks Disk0200 and Disk0202 (as indicated by solid lines).

FIG. 14B illustrates the logical machine information 1000 corresponding to the system illustrated in FIG. 14A. In FIG. 14B, the state of the logical machine SERVICE_A_{—}2 is the “currently executed” state. When the service management server 100 transmits the request to activate the logical machine SERVICE_A_{—}2 to the infrastructure management server 200, the process 909 illustrated in FIGS. 9A-9B proceeds from the process 909 to the process 910 due to the update of the coupling information of the disk Disk0200 to the “uncoupled” state as illustrated in FIG. 13C, the logical machine SERVICE_A_{—}2 is activated, and the state of the logical machine SERVICE_A_{—}2 is updated to the “currently executed” state.

FIG. 14C illustrates the disk resource management information 1100 corresponding to the system illustrated in FIG. 14A. In FIG. 14C, the coupling information of the disks Disk0200 and Disk0202 is updated to the “coupled” state. This is due to the fact that the state of the logical machine SERVICE_A_{—}2 is the “currently executed” state and the logical machine SERVICE_A_{—}2 is coupled to the disk Disk0200 as illustrated in FIG. 14B and coupled to the disk Disk0202 by the process illustrated in FIGS. 9A-9B in response to the request provided by the service management server 100 to activate the logical machine SERVICE_A_{—}2.

In the embodiment, the infrastructure management server 200 approves that the disk Disk0200 is assigned to the logical machine SERVICE_A_{—}2 in the exclusively shared assignment mode and the disk Disk0202 is assigned to the logical machine SERVICE_A_{—}2 in the dedicated assignment mode, and the assignments are managed with the disk resource management information 1100. Thus, the logical machine SERVICE_A_{—}2 is enabled to be coupled to the disks Disk0200 and Disk0202 by the process 910 illustrated in FIGS. 9A-9B in response to the request provided by the service management server 100 to activate the logical machine SERVICE_A_{—}2. The logical machine SERVICE_A_{—}2 may access the system file stored in the disk Disk0200 and execute a process based on the mirrored data of the disk Disk0202. Specifically, even if a disk fails, the service management server 100 that provides requests to activate and stop a logical machine may switch the logical machine, switch a coupling of the disk, and continue to provide the service without waiting for switching of the disk by the disk chassis failover of the infrastructure management server 200.

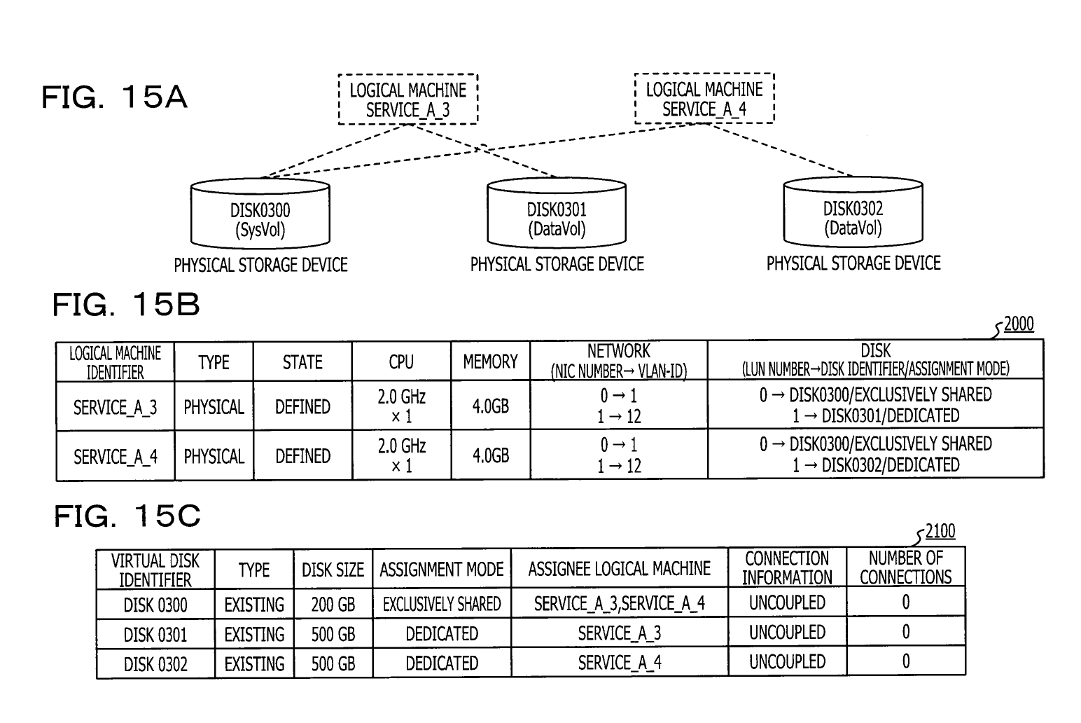

FIGS. 15A to 15C illustrate another example to which the embodiment is applicable. In the example illustrated in FIGS. 15A to 15C, the service management server 100 provides the service using a logical machine SERVICE_A_{—}3 to which a disk Disk0300 storing a system file and a disk Disk0301 storing operation-related data are assigned, and a logical machine SERVICE_A_{—}4 to which a disk Disk0302 storing test data is assigned tests the system file stored in the disk Disk0300. For example, a correction of the system file is tested by the logical machine SERVICE_A_{—}4. When the test is normally terminated, the correction of the system file is reflected and the logical machine SERVICE_A_{—}3 is executed in accordance with the corrected system file.

As illustrated in FIG. 15A, the disk Disk0300 storing the system file and the disk Disk0301 storing the operation-related data are assigned to the logical machine SERVICE_A_{—}3 (as indicated by dotted lines), while the disk Disk0300 and the disk Disk0302 storing the test data are assigned to the logical machine SERVICE_A_{—}4 (as indicated by dotted lines). The service management server 100 requests the infrastructure management server 200 to assign specifications of the system illustrated in FIG. 15A, and the infrastructure management server 200 assigns the requested specifications from the cloud platform (servers to be managed and disk resource pool) managed by the infrastructure management server 200, and whereby the logical machines SERVICE_A_{—}3 and SERVICE_A_{—}4 are executed using the cloud platform.

FIG. 15B illustrates logical machine management information 2000 corresponding to the system illustrated in FIG. 15A. Assignments of resources to the logical machines SERVICE_A_{—}3 and SERVICE_A_{—}4 are requested by the service management server 100, the process illustrated in FIGS. 6A-6B is executed by the infrastructure management server 200, and whereby the logical machine management information 2000 illustrated in FIG. 15B is created and stored in the database of the infrastructure management server 200.

The disk Disk0300 is assigned to the logical machine SERVICE_A_{—}3 in the exclusively shared assignment mode, while the disk Disk0301 is assigned to the logical machine SERVICE_A_{—}3 in the dedicated assignment mode. In the state illustrated in FIG. 15A, the state of the logical machine SERVICE_A_{—}3 is “defined” by the infrastructure management server 200 and not activated and coupled to the disks Disk0300 and Disk0301. The disk Disk0300 is assigned to the logical machine SERVICE_A_{—}4 in the exclusively shared assignment mode, while the disk Disk0302 is assigned to the logical machine SERVICE_A_{—}4 in the dedicated assignment mode.

FIG. 15C illustrates disk resource management information 2100 corresponding to the system illustrated in FIG. 15A. The assignments of the resources to the logical machines SERVICE_A_{—}3 and SERVICE_A_{—}4 are requested by the service management server 100, the process illustrated in FIGS. 6A-6B is executed by the infrastructure management server 200, and whereby the disk resource management information 2100 illustrated in FIG. 15C is created and stored in the database of the infrastructure management server 200. The disk Disk0300 is associated with the exclusively shared assignment mode and the logical machines SERVICE_A_{—}3 and SERVICE_A_{—}4 as assignee logical machines. The disk Disk0301 is associated with the dedicated assignment mode and the logical machine SERVICE_A_{—}3 as an assignee logical machine. The disk Disk0302 is associated with the dedicated assignment mode and the logical machine SERVICE_A_{—}4 as an assignee logical machine. As described above, the logical machines SERVICE_A_{—}3 and SERVICE_A_{—}4 are only “defined” and are not activated. Thus, the process illustrated in FIGS. 9A-9B is not executed, and the coupling information of the disks Disk0300, Disk0301, and Disk0302 indicates the “uncoupled” state.

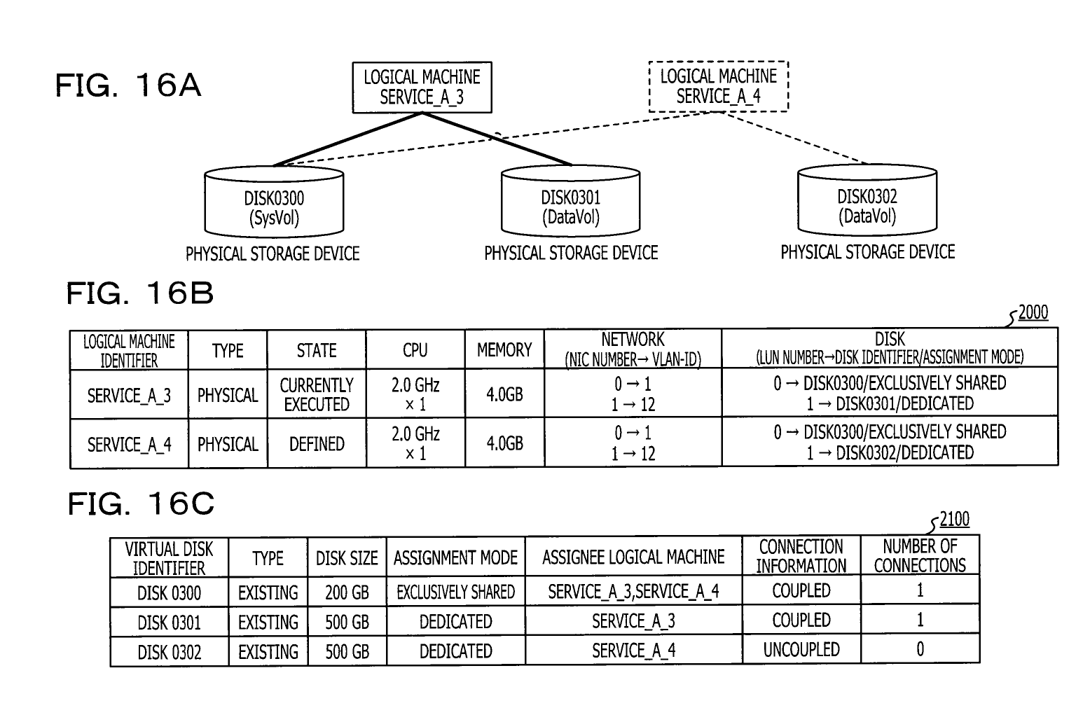

FIGS. 16A to 16C illustrate an example in which the service is provided by the logical machine SERVICE_A_{—}3. In the example illustrated in FIGS. 16A to 16C, the service management server 100 transmits a request to activate the logical machine SERVICE_A_{—}3 to the infrastructure management server 200 and the logical machine SERVICE_A_{—}3 is executed. As illustrated in FIG. 16A, the logical machine SERVICE_A_{—}3 is coupled to the disks Disk0300 and Disk0301 (as indicated by solid lines).

FIG. 16B illustrates the logical machine management information 2000 corresponding to the system illustrated in FIG. 16A. The logical machine management information 2000 is created based on the process illustrated in FIGS. 6A-6B and stored in the database of the infrastructure management server 200. The difference between the logical machine management information illustrated in FIG. 16B and the logical machine management information illustrated in FIG. 15B is that the state of the logical machine SERVICE_A_{—}3 is the “currently executed” state since the logical machine SERVICE_A_{—}3 is executed.

FIG. 16C illustrates the disk resource management information 2100 corresponding to the system illustrated in FIG. 16A. The disk resource management information 2100 is created based on the process illustrated in FIGS. 6A-6B and stored in the database of the infrastructure management server 200. The disk Disk0300 is assigned to the logical machines SERVICE_A_{—}3 and SERVICE_A_{—}4 in the exclusively shared assignment mode. The disk Disk0300 is coupled to the logical machine SERVICE_A_{—}3 activated based on the activation request provided by the service management server 100, but is not coupled to the logical machine SERVICE_A_{—}4. Since the logical machine SERVICE_A_{—}3 is coupled to the disk Disk0300, the coupling information of the disk Disk0300 indicates the “coupled” state in the disk resource management information 2100. In this case, the logical machine SERVICE_A_{—}3 reads and writes the system file from and in the disk Disk0300 and the logical machine SERVICE_A_{—}4 does not overwrite the system file.

Since the logical machine SERVICE_A_{—}3 is coupled to the disk Disk0301 in the dedicated assignment mode, the coupling information of the disk Disk0301 indicates the “coupled” state in the disk resource management information 2100. The logical machine SERVICE_A_{—}4 is not coupled to the disk Disk0301. Thus, the contents of data to be used during an operation are protected even when the test is executed.

The disk Disk0302 for the test is assigned to the logical machine SERVICE_A_{—}4 in the dedicated assignment mode. Since the logical machine SERVICE_A_{—}4 is a logical machine for the test, the logical machine SERVICE_A_{—}4 is not activated until the service management server 100 provides a request to activate the logical machine SERVICE_A_{—}4, and the logical machine SERVICE_A_{—}4 is not coupled to the disk Disk0302. Since the disk Disk0302 is assigned to the logical machine SERVICE_A_{—}4 and not coupled to the logical machine SERVICE_A_{—}4, the logical machine SERVICE_A_{—}4 does not read and write data from and in the disk Disk0302.

The case where the service management server 100 transmits a request to activate the logical machine SERVICE_A_{—}4 to the infrastructure management server 200 is described below. When the service management server 100 transmits the request to activate the logical machine SERVICE_A_{—}4, the infrastructure management server 200 executes the process illustrated in FIGS. 9A-9B as a process of coupling the logical machine SERVICE_A_{—}4 to a disk. The logical machine SERVICE_A_{—}4 tries to be coupled to the disk Disk0300 in the exclusively shared assignment mode. The disk Disk0300, however, is already coupled to the logical machine SERVICE_A_{—}3, and the coupling information of the disk Disk0300 indicates the “coupled” state and does not indicate the “uncoupled” state in the disk resource management information 2100. Thus, the coupling fails in the process 909 illustrated in FIGS. 9A-9B. As a result, the infrastructure management server 200 notifies the service management server 100 of an error in the process 905, and the logical machine SERVICE_A_{—}4 is not coupled to the disk Disk0300 and activated.

The logical machine SERVICE_A_{—}4 is a logical machine for the test of the logical machine SERVICE_A_{—}3 and enabled to be coupled to the disk Disk0302 for the test. In order to execute the logical machine SERVICE_A_{—}4 as a logical machine for the test, system information, stored in the disk Disk0300, of the logical machine SERVICE_A_{—}3 is used. As described with reference to FIGS. 16A to 16C, however, the coupling information of the disk Disk0300 indicates the “coupled” state, the logical machine SERVICE_A_{—}4 is not coupled to the disk Disk0300, and the test is not executed. As described later, in the embodiment, a process of releasing a coupling of a logical machine to a disk is executed based on an instruction of the service management server 100, and an exclusive coupling of a logical machine to a disk is executed based on an instruction of the service management server 100.

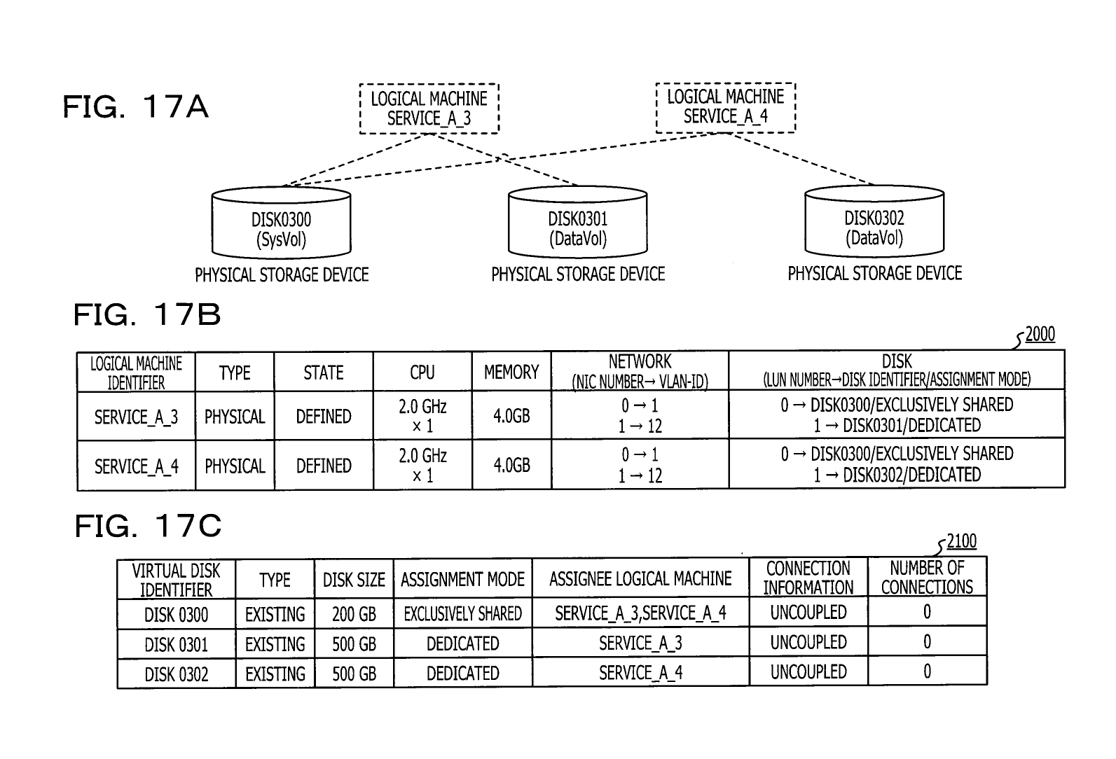

FIGS. 17A to 17C illustrate an example in which the connections of the logical machine SERVICE_A_{—}3 to the disks are released. FIG. 17A illustrates that the connections of the logical machine SERVICE_A_{—}3 to the disks Disk0300 and Disk0301 are released (as indicated by dotted lines) by causing the service management server 100 to transmit a request to stop the logical machine SERVICE_A_{—}3 to the infrastructure management server 200.

FIG. 17B illustrates the logical machine management information 2000 corresponding to the system illustrated in FIG. 17A. In FIG. 17B, the state of the logical machine SERVICE_A_{—}3 is updated to the “defined” state. According to the embodiment, the service management server 100 transmits the request to stop the logical machine SERVICE_A_{—}3, and whereby the state of the logical machine SERVICE_A_{—}3 is updated from the “currently executed” state to the “defined” state in the logical machine management information 2000 managed by the infrastructure management server 200.

FIG. 17C illustrates the disk resource management information 2100 corresponding to the system illustrated in FIG. 17A. In FIG. 17C, the coupling information of the disks Disk0300 and Disk0301 is updated to the “uncoupled” state. According to the embodiment, since the state of the logical machine SERVICE_A_{—}3 is updated to the “defined” state by the request to stop the logical machine SERVICE_A_{—}3, the coupling information of the disk Disk0300 is switched to the “uncoupled” state in the disk resource management information 2100 managed by the infrastructure management server 200. Specifically, the coupling of the logical machine SERVICE_A_{—}3 to the disk Disk0300 may be released by the service management server 100. In addition, since the state of the logical machine SERVICE_A_{—}3 is updated to the “defined” state by the request to stop the logical machine SERVICE_A_{—}3, the coupling information of the disk Disk0301 is switched to the “uncoupled” state in the disk resource management information 2100 managed by the infrastructure management server 200. Specifically, the coupling of the logical machine SERVICE_A_{—}3 to the disk Disk0301 may be released by the service management server 100.

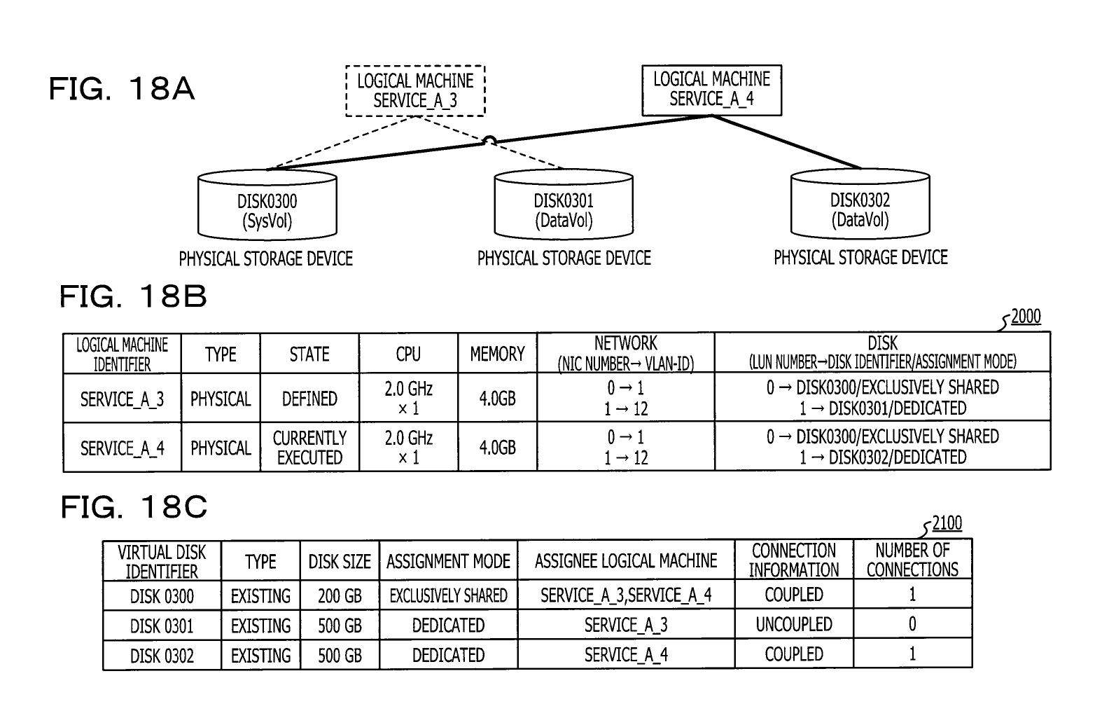

FIGS. 18A to 18C illustrate an example in which the logical machine SERVICE_A_{—}4 for the test is coupled to the disks Disk0300 and Disk0302 in the exclusively shared assignment mode. FIG. 18A illustrates that the logical machine SERVICE_A_{—}4 is coupled to the disks Disk0300 and Disk0302 (as indicated by solid lines) by causing the service management server 100 to transmit a request to activate the logical machine SERVICE_A_{—}4 to the infrastructure management server 200.

FIG. 18B illustrates the logical machine management information 2000 corresponding to the system illustrated in FIG. 18A. In FIG. 18B, the state of the logical machine SERVICE_A_{—}4 is the “currently executed” state. This is due to the fact that when the service management server 100 transmits the request to activate the logical machine SERVICE_A_{—}4 to the infrastructure management server 200, the process 909 illustrated in FIGS. 9A-9B proceeds to the process 910 due to the coupling information, updated to the “uncoupled” state, of the disk Disk0300, the logical machine SERVICE_A_{—}4 is activated, and the state of the logical machine SERVICE_A_{—}4 is updated to the “currently executed” state.

FIG. 18C illustrates the disk resource management information 2100 corresponding to the system illustrated in FIG. 18A. In FIG. 18C, the coupling information of the disks Disk0300 and Disk0302 is updated to the “coupled” state. This is due to the fact that the state of the logical machine SERVICE_A_{—}4 is the “currently executed” state and the logical machine SERVICE_A_{—}4 is coupled to the disk Disk0300 as illustrated in FIG. 18B and is coupled to the disk Disk0302 by the process illustrated in FIGS. 9A-9B in response to the request provided by the service management server 100 to activate the logical machine SERVICE_A_{—}4.

In the embodiment, the infrastructure management server 200 approves that the disk Disk0300 is assigned to the logical machine SERVICE_A_{—}4 in the exclusively shared assignment mode and the disk Disk0302 is assigned to the logical machine SERVICE_A_{—}4 in the dedicated assignment mode, and the assignments are managed using the disk resource management information 2100. Thus, the logical machine SERVICE_A_{—}4 may be coupled to the disks Disk0300 and Disk0302 by the process 910 illustrated in FIGS. 9A-9B in response to the request provided by the service management server 100 to activate the logical machine SERVICE_A_{—}4. The logical machine SERVICE_A_{—}4 may access the system file stored in the disk Disk0300 and execute a process based on the test data stored in the disk Disk0302.

When the test that is executed by the logical machine SERVICE_A_{—}4 is terminated, the service management server 100 transmits a request to stop the logical machine SERVICE_A_{—}4 to the infrastructure management server 200. When the infrastructure management server 200 receives the request to stop the logical machine SERVICE_A_{—}4, the state of the logical machine SERVICE_A_{—}4 is updated to the “defined” state in the logical machine management information 2000, and the coupling information of the disks Disk0300 and Disk0302 is updated to the “uncoupled” state in the disk resource management information 2100. By these processes, the connections of the logical machine SERVICE_A_{—}4 to the disks Disk0300 and Disk0302 are released. After that, when the service management server 100 transmits a request to activate the logical machine SERVICE_A_{—}3 to the infrastructure management server 200, the logical machine SERVICE_A_{—}3 may be coupled to the disk Disk0300 in the exclusively shared assignment mode. This is due to the fact that the coupling information of the disk Disk0300 is the “uncoupled” state. In addition, the logical machine SERVICE_A_{—}3 may be coupled to the disk Disk0301 in the dedicated assignment mode. Thus, the logical machine SERVICE_A_{—}3 may be coupled to the disk Disk0300 storing the system file corrected by the test executed by the logical machine SERVICE_A_{—}4 and may operate the service.

In the aforementioned example, the disk Disk0300 is exclusively shared by the logical machines SERVICE_A_{—}3 and SERVICE_A_{—}4, and the system file is not overwritten by one of the logical machines SERVICE_A_{—}3 and SERVICE_A_{—}4 during the time when the other logical machine SERVICE_A_{—}3 or SERVICE_A_{—}4 is coupled to the disk Disk0300. In addition, since it is sufficient if the logical machines SERVICE_A_{—}3 and SERVICE_A_{—}4 are switched, a procedure error may be inhibited during the correction of the system file. Since the disk Disk0301 is assigned to the logical machine SERVICE_A_{—}3 in the dedicated assignment mode and the disk Disk0302 is assigned to the logical machine SERVICE_A_{—}4 in the dedicated assignment mode, the assignments inhibit the data stored in the disk Disk0301 and used for the operation of the service from being broken during the test and inhibit information from leaking. According to the embodiment, the service management server 100 that provides the requests to activate and stop the logical machines switches the logical machines and thereby switches connections of the disks during the test operation without the authority of the infrastructure management server 200.

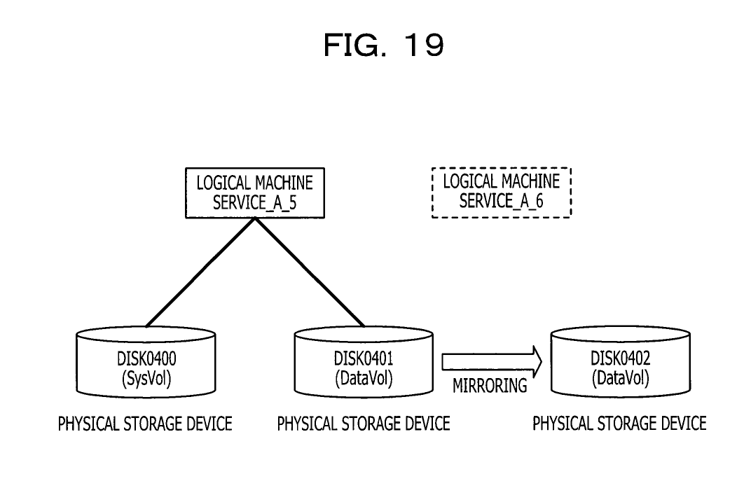

FIG. 19 illustrates an example in which logical machines are switched without using the exclusively shared assignment mode. A logical machine SERVICE_A_{—}5 is coupled to a disk Disk0400 storing a system file and a disk Disk0401 storing data. In this case, the logical machine SERVICE_A_{—}5 is coupled to the disks Disk0400 and Disk0401 in the dedicated assignment mode so as to inhibit the data stored in the disks Disk0400 and Disk0401 from being broken due to a coupling of another logical machine. It is assumed that if a failure occurs to the disk Disk0401, the logical machine SERVICE_A_{—}5 is coupled to a disk Disk0402 storing data obtained by mirroring the data stored in the disks Disk0400 and Disk0401 and continues to provide the service.

In order to couple the logical machine SERVICE_A_{—}5 to the disk Disk0402 in the dedicated assignment mode, the service management server 100 temporarily deletes a definition to be used to couple the logical machine SERVICE_A_{—}5 to the disk Disk0401 in the dedicated assignment mode. Then, the service management server 100 transmits, to the infrastructure management server 200, definition information to be used to couple the logical machine SERVICE_A_{—}5 to the disk Disk0402 in the dedicated assignment mode. The infrastructure management server 200 receives the definition information and executes the process illustrated in FIGS. 6A-6B. If the disk Disk0402 is enabled to be assigned, the infrastructure management server 200 associates the disk Disk0402 with the dedicated assignment mode and the logical machine SERVICE_A_{—}5 as an assignee logical machine and notifies the service management server 100 that the disk Disk0402 is enabled to be assigned. The service management server 100 receives the notification and transmits a request to activate the logical machine SERVICE_A_{—}5 to the infrastructure management server 200 since the assignment of the disk Disk0402 is completed. The infrastructure management server 200 receives the request to activate the logical machine SERVICE_A_{—}5, changes the coupling information of the disk Disk0402 to the “coupled” state in the disk resource management information 500, couples the logical machine SERVICE_A_{—}5 to the disk Disk0402, and activates the logical machine SERVICE_A_{—}5.

The example describes that the disk coupled in the dedicated assignment mode is changed. After the definition information of the logical machine is deleted from the infrastructure management server 200, the other definition information is transmitted to the infrastructure management server 200. Specifically, the service management server 100 executes the series of processes and waits for approval of the infrastructure administrator for the series of processes.

Next, it is assumed that if a failure occurs to the disk Disk0401, a logical machine SERVICE_A_{—}6 is coupled to the disk Disk0402 storing the data obtained by mirroring the data stored in the disks Disk0400 and Disk0401 and continues to provide the service.

If both logical machine SERVICE_A_{—}5 and logical machine SERVICE_A_{—}6 are coupled to the disk Disk0400 storing the system file, the system file is updated by the logical machines SERVICE_A_{—}5 and SERVICE_A_{—}6 and may not be normal. Thus, if the exclusively shared assignment mode is not used, the logical machine SERVICE_A_{—}5 is coupled to the disk Disk0400 in the dedicated assignment mode and the service is operated. In addition, if the exclusively shared assignment mode is not used, an assignee logical machine of the disk Disk0400 is the logical machine SERVICE_A_{—}5 in the disk resource management information 500 managed by the infrastructure management server 200, and the logical machine SERVICE_A_{—}6 is not registered. Specifically, in order to set the logical machine SERVICE_A_{—}6 as an assignee logical machine of the disk Disk0400, the definition of the logical machine SERVICE_A_{—}5 is temporarily deleted from the disk resource management information 500. Then, the service management server 100 transmits, to the infrastructure management server 200, definition information indicating a request to assign the logical machine SERVICE_A_{—}6 to the disk Disk0400 in the dedicated assignment mode.

In the examples described with reference to FIG. 19, the assignments in the dedicated assignment mode are switched so as not to cause an inconsistency in the system file. In the examples, the definition information is temporarily deleted, the other definition information is registered, and the infrastructure management server 200 approves the assignments of the disks.

According to the embodiment, the service management server 100 that manages activation and stop of a logical machine may change a coupling of a disk to the logical machine without the authority of the infrastructure management server 200. For example, coupling information of a disk is changed to the “uncoupled” state in the information managed by the infrastructure management server 200 based on a request to stop a logical machine coupled to the disk. When the coupling information is changed to the “uncoupled” state in the information, the process of releasing the coupling of the logical machine to the disk is executed. In addition, when the coupling information of the disk indicates the “uncoupled” state in the information, activation of a logical machine that shares the disk in the exclusively shared assignment mode is permitted, an exclusive coupling of the logical machine to the disk is ensured, and data is inhibited from being broken due to simultaneous connections of logical machines to the disk.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing system comprising:
a memory configured to store a program; and
a processing device, based on the program, configured to:
set, coupling information defining a logically coupling corresponding to a first disk, to an uncoupled state indicating that the first disk are not coupled to a first logical machine associated with the first disk, in response to a request to stop the first logical machine; and
release a coupling between the first logical machine and the first disk based on the uncoupled state set in the coupling information.

2. The information processing system according to claim 1, wherein the processing device is configured to:
change the coupling information set to the uncoupled state, to a coupled state in response to an activation request to activate a second logical machine associated with the first disk; and
couple the second logical machine to the first disk.

3. The information processing system according to claim 1, wherein the processing device is configured to:
receive an activation request to activate a second logical machine associated with the first disk; and
control the second logical machine to not be coupled to the first disk in response to the activation request when the coupling information is set to a coupled state.

4. The information processing system according to claim 2, wherein
the second logical machine is a backup first logical machine for the first logical machine,
system information of the second logical machine is stored in the first disk, and
the processing device is configured to control execution, based on the system information, of the backup first logical machine coupled to the first disk upon reception of the activation request.

5. The information processing system according to claim 4, wherein
data to be processed by the first logical machine is stored in a second disk that is different from the first disk, and
the processing device is configured to:
mirror the data stored in the second disk to a backup disk; and
couple the backup first logical machine to the backup disk upon reception of the activation request.

6. The information processing system according to claim 2, wherein
the second logical machine is a test first logical machine that tests system information of the first logical machine,
the system information is stored in the first disk, and
the processing device is configured to control testing the system information by the test first logical machine coupled to the first disk upon reception of the activation request.

7. The information processing system according to claim 6, wherein
data to be processed by the first logical machine is stored in a second disk that is different from the first disk;
test data used to test the system information is stored in a test disk; and
the circuitry is configured to control coupling the test first logical machine to the test disk upon reception of the activation request.

8. The information processing system according to claim 2, wherein the processing device is configured to:
associate the first logical machine with the first disk;
associate the second logical machine with the first disk; and
register the association of the first logical machine with the first disk and the association of the second logical machine with the first disk prior to reception of the activation request.

9. The information processing system according to claim 8, wherein
the association of the first logical machine with the first disk and the association of the second logical machine with the first disk indicate that the first logical machine and the second logical machine are set in an exclusively shared mode, the first logical machine and the second logical machine exclusively coupling the first disk in the exclusively shared mode.

10. The information processing system according to claim 5, wherein
the processing device is configured to associate the second logical machine with the second disk.

11. The information processing system according to claim 10, wherein
the association of the first logical machine with the second disk indicates that the first logical machine may be coupled to the second disk in a dedicated mode.

12. The information processing system according to claim 1, wherein
the request to stop the first logical machine is received from a first manager configured to manage the first logical machine.

13. The information processing system of claim 12, wherein
the first manager is different from a second manager configured to physically allocate the first disk to the first logical machine.

14. A computer-readable recording medium having stored therein a program for causing an information processing system to:
set, coupling information defining a logically coupling corresponding to a first disk, to an uncoupled state indicating that a first logical machine associated with the first disk and the first disk are not coupled, in response to a request to stop the first logical machine; and
release a coupling between the first logical machine and the first disk based on the uncoupled state set in the coupling information.

15. An information processing method comprising:
setting, coupling information defining a logically coupling corresponding to a first disk, to an uncoupled state indicating that a first logical machine associated with the first disk and the first disk are not coupled, in response to a request to stop the first logical machine; and
releasing a coupling between the first logical machine and the first disk based on the uncoupled state set in the coupling information.

16. An information processing system comprising:
a memory configured to store a program; and
a processing device, based on the program, configured to:
assign a plurality of logical machines with a disk;
couple the first logical machine of the plurality of logical machines, to the disk when the disk is not logically coupled to any one of the plurality of logical machines.
